(19) United States
(12) Patent Application Publication
(10) Pub. No.: US 2026/0084444 A1
(43) Pub. Date: Mar. 26, 2026

(54) PRINTING APPARATUS AND CONTROL METHOD

(71) Applicant: CANON KABUSHIKI KAISHA, Tokyo (JP)

(72) Inventors: Yuma Sato, Kanagawa (JP); Naoki Wakayama, Kanagawa (JP); Kenji Sugiyama, Kanagawa (JP); Yuya Nanji, Kanagawa (JP); Keisuke Kagita, Tokyo (JP); Kenji Kubozono, Tokyo (JP)

(21) Appl. No.: 19/332,226

(22) Filed: Sep. 18, 2025

(30) Foreign Application Priority Data
Sep. 20, 2024 (JP) 2024-163989

(51) Int. Cl. B41J 11/00

(52) U.S. Cl. CPC B41J 11/0095; B41J 11/0065; B41J 11/008

(57) ABSTRACT

A printing apparatus includes: a first detection unit movable in a width direction and configured to detect an end portion position of a print medium while being switched between first and second modes; an obtaining unit configured to obtain position information of the end portion based on outputs from the first detection unit in the first and second modes; an adjusting unit configured to execute first output adjustment of adjusting the output in the first mode and second output adjustment of adjusting the output in the second mode; and a print control unit capable of selectively executing first printing in which the position information is not obtained during printing and second printing in which the position information is obtained during printing, and the adjusting unit executes the first output adjustment before the first printing, and executes the first output adjustment and the second output adjustment before the second printing.

### BACKGROUND

### Field of the Technology

The present disclosure relates to a printing apparatus and a control method.

### Description of the Related Art

Assume a case where a printing apparatus configured to perform printing on a print medium by ejecting ink by an inkjet method performs marginless printing in which printing is performed without a margin provided in an end portion of the print medium. In this case, if an accuracy of detecting an end portion position of the print medium is low, the low detection accuracy provokes soiling in the apparatus and formation of a margin. Japanese Patent Laid-Open No. 2004-182361 discloses a technique in which a single detection part is used to detect the end portion position of the print medium based on a detection signal corresponding to reflected light from the print medium. Moreover, Japanese Patent Laid-Open No. 2004-182361 discloses a technique in which output values at multiple locations on the print medium are obtained from a sensor to suppress a decrease in end portion detection accuracy caused by effects of environment changes, and output adjustment of the sensor is performed based on these output values.

However, in a configuration including multiple varying sensors, the output adjustment of Japanese Patent Laid-Open No. 2004-182361 needs to be performed in each of the sensors before printing, and a long time period is required before execution of printing.

### SUMMARY

The present disclosure has been made in view of the above-mentioned problem, and provides a technique that can suppress an increase in a waiting time period before execution of printing.

A printing apparatus according to some embodiments includes a carriage in which a print head configured to perform printing by ejecting ink to a conveyed print medium is mounted, the carriage movable in a width direction of the print medium intersecting a conveyance direction of the print medium; a first detection unit provided in the carriage and including a light emitting part configured to emit light to the print medium and three light receiving parts configured to receive reflected light from the print medium and provided at positions varying from one another in the width direction, the first detection unit capable of being switched between a first mode in which the first detection unit detects an end portion of the print medium based on an output corresponding to an amount of received light in one of the light receiving parts and a second mode in which the first detection unit detects the end portion based on a difference between outputs corresponding to amounts of received light in two of the light receiving parts not used in the first mode; an obtaining unit configured to obtain position information of the end portion based on an output from the first detection unit in the first mode and obtain the position information of the end portion based on an output from the first detection unit in the second mode; an adjusting unit configured to execute first output adjustment in which the adjusting unit adjusts the output from the first detection unit in the first mode and second output adjustment in which the adjusting unit adjusts the output from the first detection unit in the second mode; and a print control unit capable of selectively executing first printing in which the position information of the end portion is not obtained during printing and second printing in which the position information of the end portion is obtained during printing, wherein the adjusting unit executes the first output adjustment before execution of the first printing, and executes the first output adjustment and the second output adjustment before execution of the second printing.

Features of the present disclosure will become apparent from the following description of embodiments with reference to the attached drawings. The following description of embodiments is described by way of example.

### BRIEF DESCRIPTION OF THE DRAWINGS

FIG. 1 is an external appearance diagram of a printing apparatus.

FIG. 2 is a diagram illustrating an internal configuration of the printing apparatus.

FIGS. 3A and 3B are schematic configuration diagrams of a printing part.

FIGS. 4A and 4B are schematic configuration diagrams of a first sensor and a second sensor.

FIG. 5 is a diagram illustrating light receiving elements provided in a light receiving member.

FIG. 6 is a block diagram focusing on a configuration of a control system of the printing apparatus.

FIGS. 7A to 7C are diagrams explaining changes in an output voltage of the first sensor.

FIG. 8 is a diagram illustrating an output waveform illustrating changes in the output voltage of the first sensor.

FIG. 9 is a diagram explaining operations of the second sensor in a differential mode.

FIGS. 10A to 10C are diagrams explaining an output voltage in one of light receiving units in the second sensor in the differential mode.

FIG. 11 is a diagram illustrating output waveforms illustrating changes in outputs in the differential mode.

FIG. 12 is a diagram illustrating output waveforms illustrating changes in outputs in the single mode.

FIGS. 13A to 13C are diagrams explaining output adjustment in the second sensor. FIGS. 14A to 14L are diagrams explaining an outline of micro-margin printing.

FIGS. 15A to 15J are diagrams explaining an outline of margin printing.

FIG. 16 is a flowchart illustrating details of an adjustment process.

FIG. 17 is a flowchart illustrating details of a feeding process.

FIG. 18 is a flowchart illustrating details of the adjustment process after the feeding process.

FIG. 19 is a flowchart illustrating details of the feeding process in another embodiment.

FIG. 20 is a flowchart illustrating details of the adjustment process in another embodiment.

FIG. 21 is a flowchart illustrating details of the adjustment process in another embodiment.

### DESCRIPTION OF THE EMBODIMENTS

Examples of embodiments of a printing apparatus and a control method are explained below in detail with reference to the attached drawings. Note that the following embodiments do not limit the present disclosure, and not all of combinations of features explained in the present embodiments are necessarily essential for solving means of the present disclosure. Moreover, positions, shapes, and the like of the constituent elements described in the embodiments are merely examples, and are not intended to limit the scope of the present disclosure to these positions, shapes, and the like.

### First Embodiment

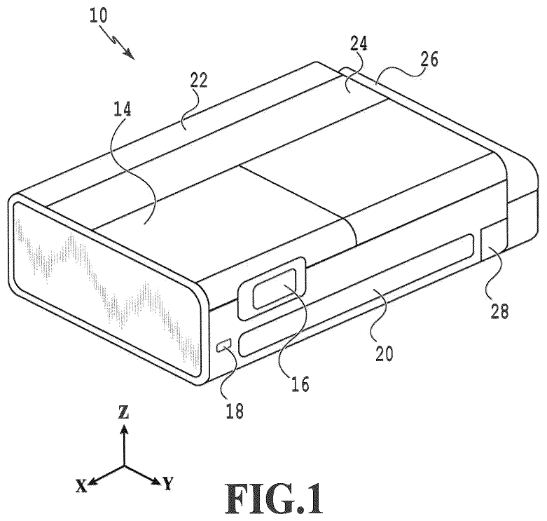

First, a printing apparatus according to a first embodiment is explained in detail with reference to FIGS. 1 to 16. Note that, in the present embodiment, explanation is given by using an inkjet printing apparatus as an example of the printing apparatus, the inkjet printing apparatus configured to perform printing on a print medium by ejecting a printing agent such as ink as a liquid by an inkjet method. The printing agent includes agents such as a treatment liquid that performs predetermined treatment on the ink ejected to the print medium.

The term “printing” is not limited to the case where meaningful information such as characters and figures are formed, but also widely includes the case where an image, a design, a pattern, or the like is formed on a print medium regardless of whether the formed object is meaningful or meaningless and the case where the print medium is processed. Whether the formed or processed objects are made apparent to be visually perceptible to humans or not does not matter. Moreover, although the “print medium” is assumed to be sheet-shaped paper in the present embodiment, the “print medium” may be cloth, plastic film, wood, cardboard, metal film, or the like.

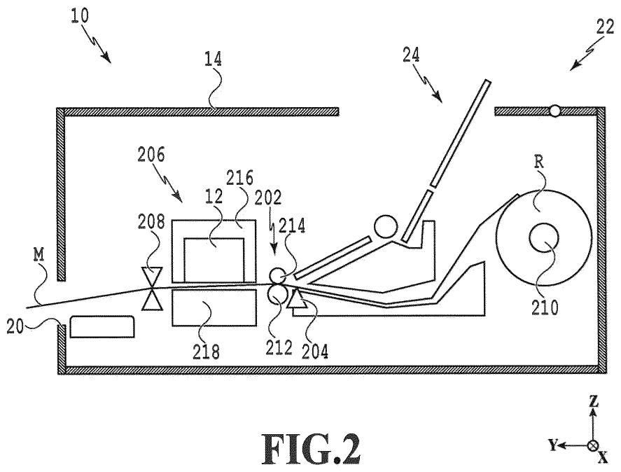

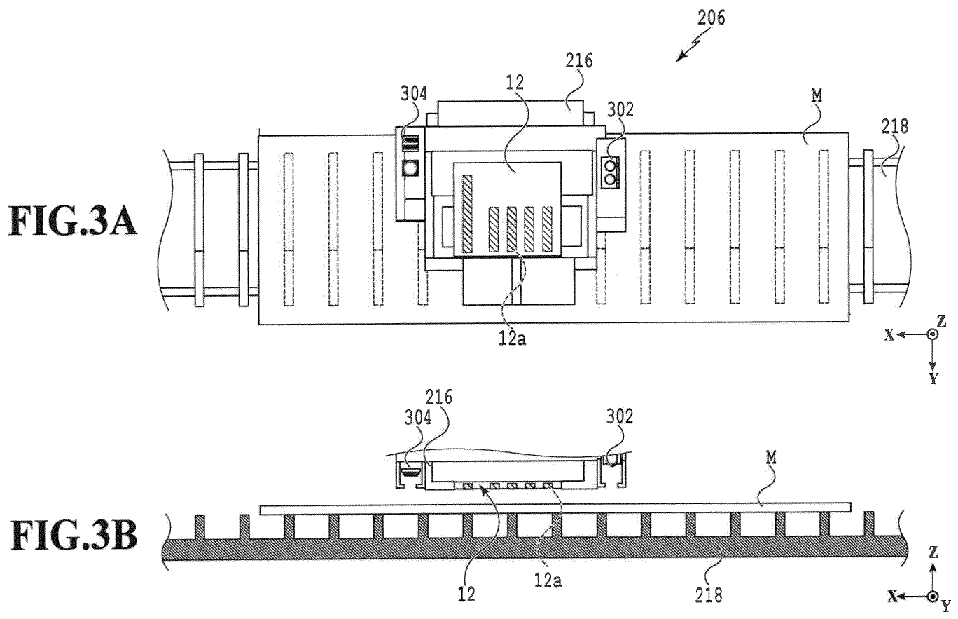

FIG. 1 is an outer appearance diagram of the printing apparatus. FIG. 2 is a diagram illustrating an internal configuration of the printing apparatus. FIGS. 3A and 3B are diagrams illustrating an outline of a configuration of a printing part, FIG. 3A is a plan view, and FIG. 3B is a front view. In the present specification, explanation is given assuming that a direction from the right side toward the left side of the printing apparatus in the case where a viewer faces the side of the printing apparatus from which a print medium subjected to printing is discharged is an X direction, a direction from the far side (rear side) to the near side (front side) of the printing apparatus is a Y direction, and a direction from the lower side toward the upper side of the printing apparatus is a Z direction. As described above, the X direction, the Y direction, and the Z direction are each a direction from one side toward the other side, and are directions orthogonal to one another. In the present specification, each of the directions is described with “+ (plus)” attached thereto in the case of the direction from the one side toward the other side, and is described with “− (minus)” attached thereto in the case of the direction from the other side toward the one side as necessary.

In the printing apparatus 10 illustrated in FIG. 1, the printing part 206 (see FIG. 3A) configured to perform printing by ejecting ink from a print head 12 (see FIG. 2) to a conveyed print medium M is housed in a case 14 (see FIG. 1). The printing apparatus 10 has a flat, substantially-rectangular-parallelepiped shape due to the case 14.

Note that the case 14 includes multiple openable-closeable covers, and opening and closing these covers enable access to members provided inside the case. The printing apparatus 10 includes, on a front face, an operation part 16 configured to display various pieces of information and receive operations made by a user, a notification part 18 configured to perform notification by audio, and a discharge part 20 from which the print medium M subjected to printing is discharged.

The printing apparatus 10 includes, on the rear side, a roll holding part 22 that holds a roll R (see FIG. 2) formed by winding a sheet-shaped print medium M and that is capable of unwinding the roll R and feeding the print medium M to the printing part 206. Moreover, the printing apparatus 10 includes a sheet feeding part 24 capable of feeding, for example, a cut-sheet-shaped print medium M with a size conforming to JIS standards, to the printing part 206. Moreover, the printing apparatus 10 includes an ink tank 26 configured to store the ink to be supplied to the print head 12 and a housing portion 28 housing a waste liquid tank (not illustrated) configured to store waste ink. Note that, although illustration is omitted, a reading unit configured to read an image of an original may be provided in the printing apparatus 10. In this case, the reading unit may be configured such that the reading unit is openable and closeable, and opening the reading unit enables access to an inside of the printing apparatus 10.

The printing apparatus 10 includes a conveyance part 202 configured to convey a sheet-shaped print medium MR fed from the roll holding part 22 and a cut-sheet-shaped print medium MC fed from the sheet feeding part 24 and a conveyance sensor 204 capable of detecting these print media M (see FIG. 2). In the present specification, the sheet-shaped print medium unwound from the roll R is referred to as “print medium MR”, and the cut-sheet-shaped print medium is referred to as “print medium MC”. In the case of referring to both of the print medium MR and the print medium MC, these print media are referred to as “print medium M”. Moreover, the printing apparatus 10 includes the printing part 206 configured to perform printing by ejecting the ink to the print medium M conveyed by the conveyance part 202 and a cutter part 208 configured to cut the print medium M subjected to the printing.

The roll holding part 22 unwinds the roll R by rotating the held roll R in a predetermined direction, and transports and feeds the print medium MR to the conveyance part 202 in the +Y direction. Moreover, the roll holding part 22 winds the print medium MR on the roll R by rotating the held roll R in the opposite direction to the predetermined direction, and transports and winds the print medium MR in the −Y direction. The roll R is held in the roll holding part 22 with a spool 210 inserted in a paper pipe, and in the roll holding part 22, the spool 210 is rotated with a motor (not illustrated) to rotate the roll R in the predetermined direction or the opposite direction.

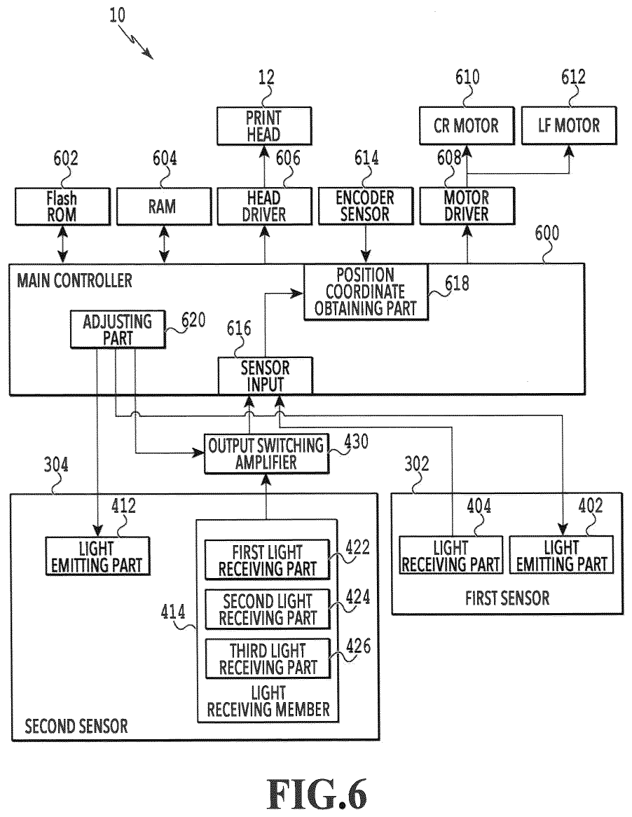

The conveyance part 202 includes a drive roller 212 configured to rotate by being driven by a line feed (LF) motor 612 (see FIG. 6) and a follower roller 214 configured to come into pressure contact with the drive roller 212 and follow the drive roller 212. The print medium M fed from the roll holding part 22 or the sheet feeding part 24 is nipped by the drive roller 212 and the follower roller 214, and is conveyed in the +Y directions by drive of the drive roller 212. For example, a gear mechanism using a motor as a drive source can be adopted as a drive mechanism of the drive roller 212. A conveyance amount of the conveyance part 202 is controlled based on, for example, a detection result of a sensor (not illustrated) such as an encoder provided in the LF motor 612. Note that a conveyance mechanism of the print medium Min the conveyance part 202 is not limited to a form using the drive roller 212 and the follower roller 214, and various publicly-known techniques can be used.

The conveyance sensor 204 is provided upstream of the conveyance part 202 in the conveyance direction (+Y direction) of the print medium M. The conveyance sensor 204 is used in operations such as determination of whether the print medium M is properly fed to the conveyance part 202 or not. The conveyance sensor 204 is, for example, an optical sensor.

The printing part 206 is arranged downstream of the conveyance part 202 in the conveyance direction (+Y direction) of the print medium M. The printing part 206 includes the print head 12 capable of ejecting the ink and a carriage 216 in which the print head 12 is mounted and that can be reciprocally moved in the X direction. The carriage 216 is provided to be slidable on a guide rail (not illustrated) extending in the X direction, and is configured to be movable from the one side toward the other side (+X direction) and from the other side toward the one side (−X direction) in the X direction by drive of a carriage motor 610 (see FIG. 6). Accordingly, in the printing apparatus 10, the print head 12 mounted in the carriage 216 can be also reciprocally moved in the X direction via the carriage 216.

For example, a belt drive mechanism using the carriage (CR) motor 610 as a drive source can be adopted as a drive mechanism of the carriage 216. A position coordinate obtaining part 618 (see FIG. 6) obtains the position of the carriage 216 based on a detection result of an encoder sensor (not illustrated), and movement of the carriage 216 can be controlled based on the obtained position information. Moreover, a tube (not illustrated) connected to the ink tank 26 is connected to the carriage 216, and the ink stored in the ink tank 26 is supplied to the print head 12 via this tube.

The printing part 206 includes the print head 12 configured to be moved via the carriage 216 and a platen 218 configured to support the print medium M conveyed by the conveyance part 202 at a position facing the print head 12. The printing part 206 has a configuration in which the print head 12 ejects the ink while being moved relative to the print medium M conveyed in the +Y direction and supported on the platen 218, via the carriage 216 in the width direction (+X directions) of the print medium M. In the present embodiment, the platen 218 has a characteristic of absorbing light emitted thereto and not reflecting or hardly reflecting the light emitted thereto. Note that nozzle arrays 12a formed by arranging multiple nozzles configured to eject the ink are formed on a surface of the print head 12 facing the platen 218. The nozzle arrays 12a extends in the Y direction intersecting (orthogonal to in the present embodiment) a movement direction (X direction) of the print head 12.

The printing apparatus 10 performs a printing operation in which printing is performed by ejecting the ink to the print medium M, conveyed to a printing start position by the conveyance part 202, based on print data while moving (scanning) the print head 12 in the X direction. Next, the conveyance part 202 conveys the print medium M by a predetermined amount, and the printing operation is performed again. As described above, the printing apparatus 10 executes the printing based on the print data on the print medium M by repeatedly, alternately executing the printing operation and the conveyance operation.

The printing part 206 includes a first sensor 302 and a second sensor 304 capable of detecting end portions of the print medium Min the X direction (see FIG. 3A). The first sensor 302 and the second sensor 304 are provided in the carriage 216, and are thereby configured to be reciprocally movable in the X direction via the carriage 216. The first sensor 302 is provided on the one side (right side) of the carriage 216 in the X direction. Meanwhile, the second sensor 304 is provided on the other side (left side) of the carriage 216 in the X direction.

The first sensor 302 and the second sensor 304 are arranged in such a positional relationship that the first sensor 302 and the second sensor 304 partially overlap the nozzle arrays 12a in the Y direction. Note that, in the printing apparatus 10, the print head 12 (carriage 216) is assumed to be located at a standby position provided on the one side in the X direction in the case where no printing is performed. This standby position is provided at a position outside a printing region in which the print head 12 performs printing by ejecting the ink to the print medium M.

Detection results of the first sensor 302 and the second sensor 304 are associated with a position on the print medium M by using a detection result of the position of the carriage 216 obtained by the encoder sensor and the conveyance amount of the print medium M by the conveyance part 202. For example, the first sensor 302 and the second sensor 304 can detect the position of the carriage 216. As described in detail later, the first sensor 302 and the second sensor 304 are optical sensors including light emitting parts and light receiving parts. In the present embodiment, the encoder sensor (not illustrated) provided in the carriage 216 reads an encoder scale (not illustrated) extending in the X direction, and coordinate information of the carriage 216 in the X direction can be thereby obtained.

The cutter part 208 includes a cutter for cutting the print medium M, and can be reciprocally moved in the X direction by a motor (not illustrated). The print medium M is thereby cut in the X direction by the cutter part 208. Note that the cutter part 208 may include a pressure sensor configured to detect pressure applied to the cutter.

### <First Sensor and Second Sensor>

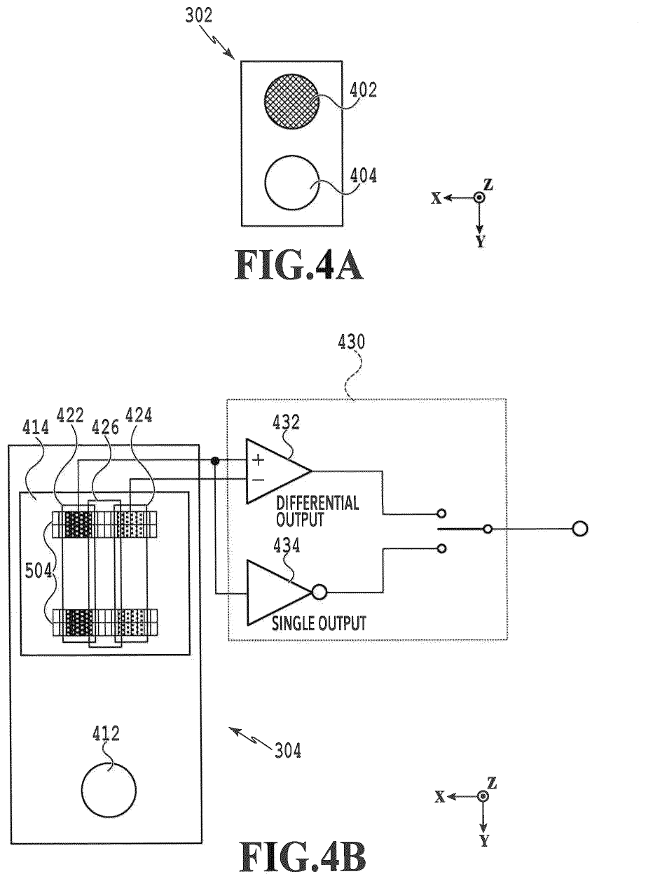

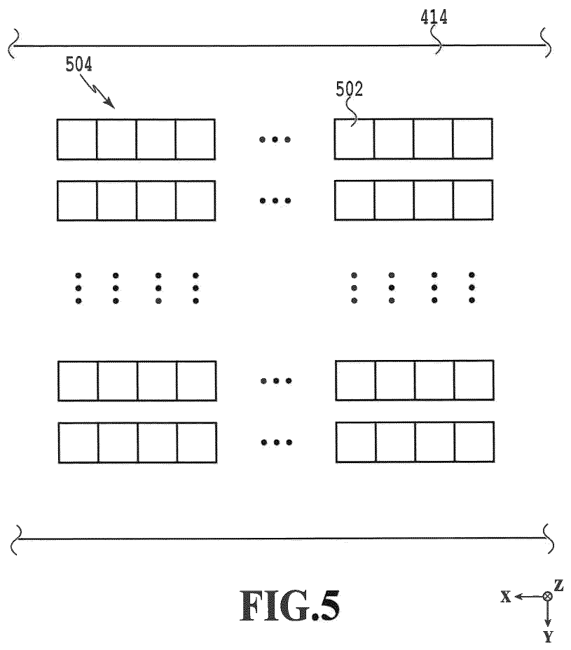

Next, configurations of the first sensor 302 and the second sensor 304 are explained. FIGS. 4A and 4B are schematic configuration diagrams of the first sensor 302 and the second sensor 304, FIG. 4A is the first sensor 302, and FIG. 4B is the second sensor 304. FIG. 5 is a diagram illustrating light receiving elements provided in a light receiving member 414.

The first sensor 302 includes a light emitting part 402 capable of emitting light to the platen 218 and the print medium M supported on the platen 218 and a light receiving part 404 capable of receiving reflected light from the platen 218 and the print medium M (see FIG. 4A). Although the light emitting part 402 is arranged on one side (rear side) of the light receiving part 404 in the Y direction in the present embodiment, the arrangement is not limited to this. For example, the light emitting part 402 may be arranged on the other side (front side) of the light receiving part 404 in the Y direction, or on the one side or the other side of the light receiving part 404 in the X direction.

The second sensor 304 includes a light emitting part 412 capable of emitting light to the platen 218 and the print medium M supported on the platen 218 and the light receiving member 414 capable of receiving reflected light from the platen 218 and the print medium M (see FIG. 4B). Although the light emitting part 412 is arranged on the other side (front side) of the light receiving member 414 in the Y direction in the present embodiment, the arrangement is not limited to this. For example, the light emitting part 412 may be arranged on the one side of the light receiving member 414 in the Y direction, or on the one side or the other side of the light receiving member 414 in the X direction.

The light receiving member 414 includes a light receiving element part 504 in which multiple light receiving elements 502 are arranged in a matrix in the X direction and the Y direction (see FIG. 5). Specifically, in the light receiving element part 504, multiple light receiving element arrays in which a predetermined number of light receiving elements are arranged side by side in the Y direction are arranged in the X direction. Note that, in the present specification, in each of the diagrams including FIG. 4B in which the light receiving element part 504 is illustrated, illustration of the light receiving elements located in the middle in the Y direction is omitted. Moreover, in the light receiving member 414, three light receiving parts are formed in the light receiving element part 504 (see FIG. 4B). Specifically, one or multiple light receiving element arrays located on the other side of the light receiving element part 504 in the X direction form a first light receiving part 422. Moreover, one or multiple light receiving element arrays located on the one side of the light receiving element part 504 in the X direction form a second light receiving part 424.

Note that, in the present embodiment, the first light receiving part 422 and the second light receiving part 424 overlap each other in the Y direction, and are provided to be spaced apart from each other in the X direction. Moreover, one or multiple light receiving element arrays that are located between the first light receiving part 422 and the second light receiving part 424 in the light receiving element part 504 and that are not used in the first light receiving part 422 and the second light receiving part 424 form a third light receiving part 426. Note that the light receiving element arrays to be used in each light receiving part may be fixed, or may be configured to be capable of being increased or reduced. In the case where the configuration in which the light receiving element arrays are increased or reduced is adopted, for example, an adjusting part 620 (see FIG. 6) increases or reduces the light receiving element arrays.

An output from each of the light receiving parts in the light receiving member 414 is inputted into an output switching amplifier 430. In the output switching amplifier 430, an output method can be switched. Specifically, the output switching amplifier 430 is configured to allow a main controller 600 to perform switching between a differential mode based on output values of the first light receiving part 422 and the second light receiving part 424 and a single mode based on an output value of the third light receiving part 426. In the differential mode, outputs from the first light receiving part 422 and the second light receiving part 424 are inputted into a differential amplifier 432 provided in the output switching amplifier 430. In the single mode, the output from the third light receiving part 426 is inputted into a single amplifier 434 provided in the output switching amplifier 430. In the present embodiment, the second sensor 304 and the output switching amplifier 430 function as a detection part that can detect the end portions of the print medium by performing output depending on the amount of received light in the light receiving parts.

### <Configuration of Control System of Printing Apparatus>

Next, a configuration of a control system of the printing apparatus 10 is explained. FIG. 6 is a block diagram illustrating the configuration of the control system of the printing apparatus 10.

The printing apparatus 10 includes the main controller 600 configured to control operations of the entire printing apparatus 10. The main controller 600 executes various processes based on programs and data held in a flash ROM 602 and a RAM 604. The flash ROM 602 is a non-volatile storage, and stores programs, parameters, correction data, and the like to be used in the various processes. The RAM 604 is a volatile storage, and temporarily holds programs, data, and the like.

The main controller 600 controls ejection of the ink from the print head 12 via a head driver 606. Moreover, the main controller 600 controls drive of various motors via a motor driver 608. The motors whose drive is controlled by the motor driver 608 include the CR motor 610 for moving the carriage 216 in the X direction and the LF motor 612 for driving the drive roller 212 configured to convey the print medium M. In addition to these motors, although illustration is omitted, a motor configured to drive a maintenance part (not illustrated) for maintaining and recovering an ejection performance of the ink from the nozzles in the print head 12 and the like are also controlled via the motor driver 608. The main controller 600 detects drive amounts of the respective motors by using encoder sensors 614 corresponding to the respective motors, and controls the drive of the motors. Encoder scales read by the encoder sensors 614 are linear scales and rotary scales. In both types of scales, a drive amount is detected based on a count number of the sensor.

Moreover, the main controller 600 is connected to the first sensor 302 and the second sensor 304. In the first sensor 302, drive of the light emitting part 402 is controlled by the main controller 600. Moreover, in the light receiving part 404 of the first sensor 302, a signal based on an amount of received light is amplified to a level suiting the main controller 600, and is obtained by a sensor input 616 of the main controller 600 as an analog input level. In the second sensor 304, drive of the light emitting part 412 is controlled by the main controller 600. Moreover, in each of the light receiving parts in the light receiving member 414 of the second sensor 304, a signal based on an amount of received light is converted in the differential amplifier 432 or the single amplifier 434 of the output switching amplifier 430, and is then amplified to the level suiting the main controller 600.

In the main controller 600, the sensor input 616 obtains the amplified signal as an analog input level. The printing apparatus 10 is configured such that a gain of the differential amplifier 432 can be changed from the main controller 600 to suit a received light signal level in an analog manner. The main controller 600 obtains position coordinates of positions detected by the first sensor 302 and the second sensor 304 in the position coordinate obtaining part 618 based on the signals obtained from the first sensor 302 and the second sensor 304 and the signals obtained from the encoder sensors 614. The main controller 600 includes the adjusting part 620 that adjusts an output such as an amplification factor for the output switching amplifier 430 and that adjusts light emitting amounts of the light emitting parts for the first sensor 302 and the second sensor 304.

### <Detection Operations by First Sensor and Second Sensor>

The print medium M is generally white, and the platen 218 has a characteristic of absorbing light, that is black in the present embodiment. Accordingly, the light emitted from each light emitting part is almost entirely reflected on the print medium M, and is almost entirely absorbed on the platen 218. Accordingly, a difference in the amount of received light in the light receiving part occurs between the print medium M and the platen 218. The first sensor 302 and the second sensor 304 detect each end portion of the print medium M based on this difference in the amount of received light in the light receiving part that occurs between the print medium M and the platen 218.

### =Detection Operation by First Sensor 302=

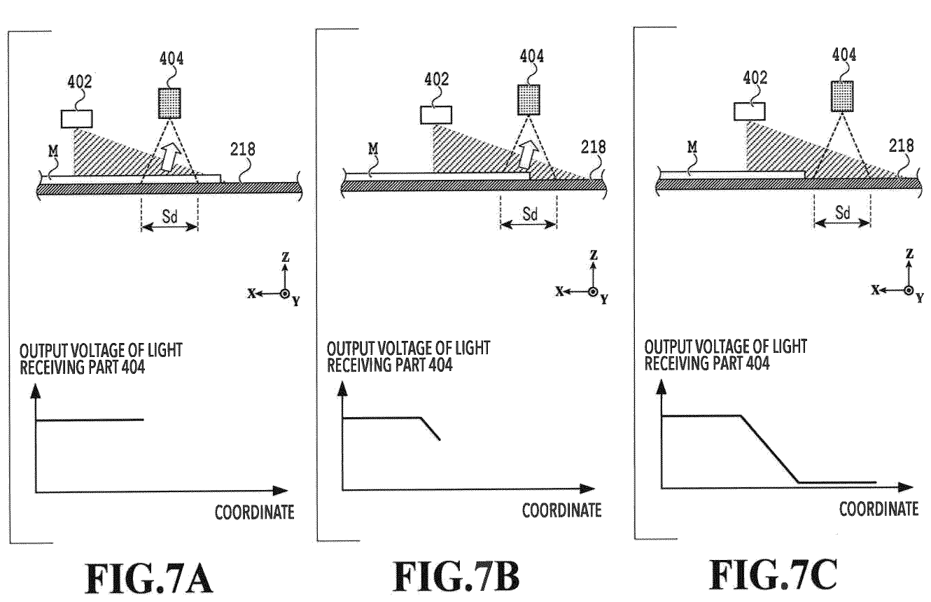

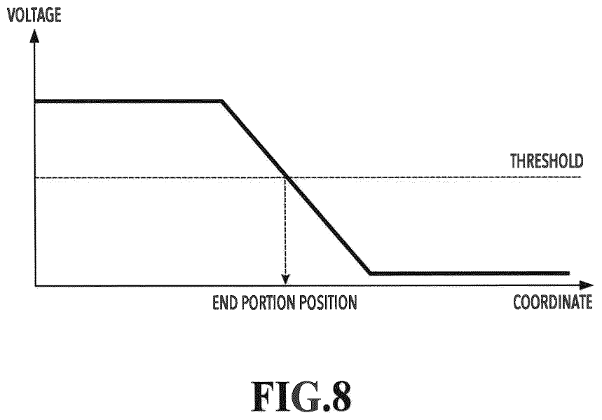

First, an outline of a detection operation by the first sensor 302 is explained. FIGS. 7A to 7C are diagrams explaining changes in the output of the first sensor 302 in three different states. FIG. 8 is a diagram illustrating an example of an output waveform of the first sensor 302. Note that, in FIGS. 7A to 7C, the light emitting part 402 is arranged at a position away from the light receiving part 404 in the X direction to facilitate understanding.

FIGS. 7A to 7C illustrate a case where the first sensor 302 is moved relative to the print medium M supported on the platen 218 from the other side toward the one side in the X direction (−X direction), above the print medium M, and the situation sequentially changes from the state illustrated in FIG. 7A to the state illustrated in FIG. 7B, and then to the state illustrated in FIG. 7C. The light receiving part 404 receives reflected light from within a spot diameter Sd of the light receiving part 404, and outputs a voltage corresponding to an amount of light by converting the received light to the voltage. The light emitting part 402 emits light to the entire region within the spot diameter Sd of the light receiving part 404.

In the case where the print medium M is located in the entire region of the spot diameter Sd, the amount of received light in the light receiving part 404 is maximized by the reflected light from the print medium M located in the spot diameter Sd, and an output voltage of the light receiving part 404 takes a maximum value (see FIG. 7A).

In the case where the first sensor 302 is moved in the −X direction from the state of FIG. 7A and the platen 218 is located in the region within the spot diameter Sd, the amount of reflected light from the spot diameter Sd decreases as a proportion of an area occupied by the platen 218 increases in the region. Accordingly, the amount of received light in the light receiving part 404 decreases in response to the movement of the first sensor 302, and the output voltage of the light receiving part 404 gradually decreases (see FIG. 7B).

Then, in the case where the first sensor 302 is further moved in the −X direction from the state of FIG. 7B and no print medium M is located, that is only the platen 218 is located in the entire region within the spot diameter Sd, almost no light is reflected from within the spot diameter Sd. Accordingly, the output voltage of the light receiving part 404 takes a minimum value (see FIG. 7C).

The output waveform based on the above-mentioned changes in the output voltage is as illustrated in FIG. 8. In a portion near the end portion of the print medium M where the proportion of the area occupied by the print medium M in the spot diameter Sd changes, the output waveform changes, and the value of the output voltage decreases in response to the decrease of the proportion. Accordingly, the output voltage at a position corresponding to an end portion position of the print medium M is set as a threshold based on this change in the output waveform, and the end portion position of the print medium M is obtained based on a coordinate in the case where the output voltage passes this threshold in the position coordinate obtaining part 618 (see FIG. 6). For example, this threshold is determined through experiments depending on the type and the like of the print medium to be used.

### =Detection Operation by Second Sensor 304=

Next, an outline of a detection operation by the second sensor 304 is explained. Note that the second sensor 304 is configured such that the mode of the second sensor 304 is selectable between the differential mode in which the first light receiving part 422 and the second light receiving part 424 are used and the single mode in which the third light receiving part 426 is used. Specifically, the second sensor 304 detects, for example, the end portion of the print medium M in the X direction by using the first light receiving part 422 and the second light receiving part 424 in the case where the differential mode is set by the main controller 600. Moreover, the second sensor 304 detects, for example, the end portion of the print medium Min the X direction by using the third light receiving part 426 in the case where the single mode is set by the main controller 600.

### Detection Operation in Differential Mode

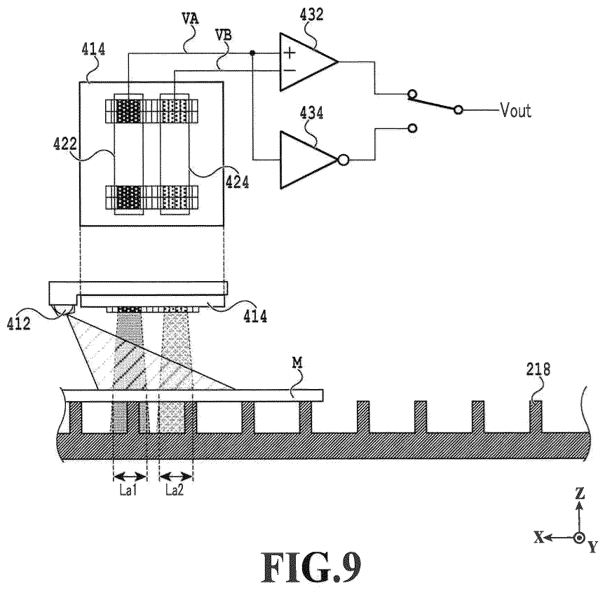

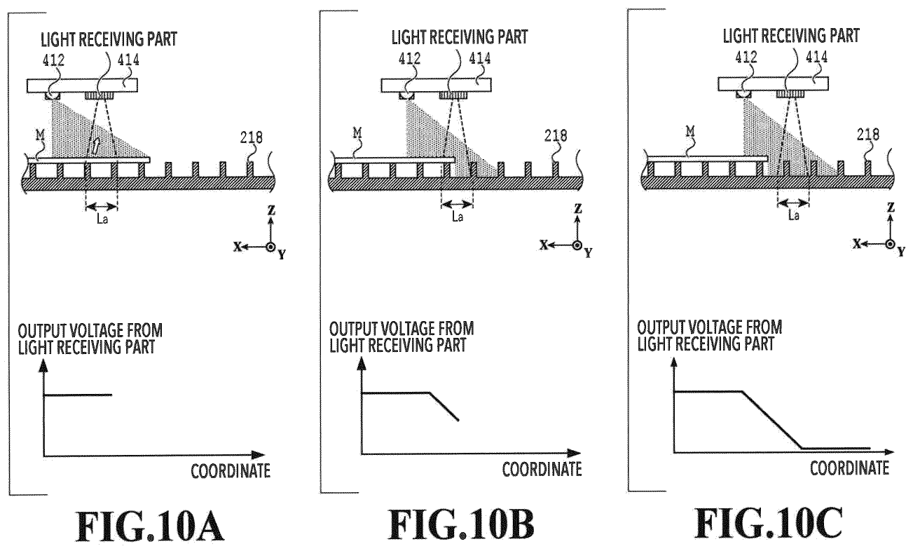

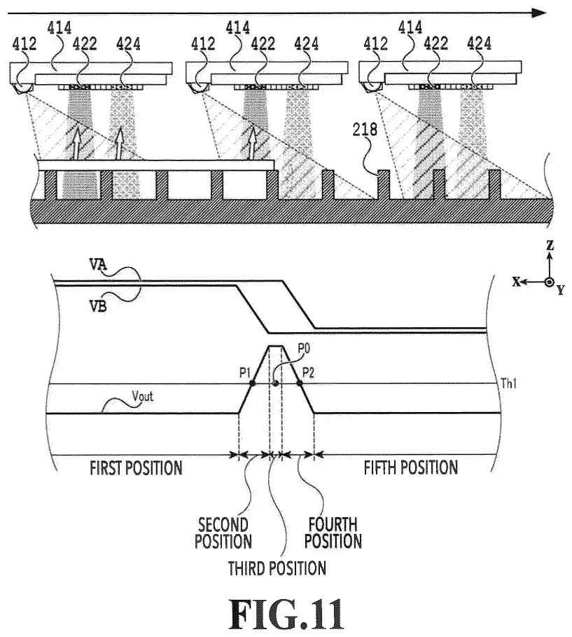

First, an outline of a detection operation in the differential mode is explained. FIG. 9 is a diagram explaining emission of light from the light emitting part 412 and reception of light in the first light receiving part 422 and the second light receiving part 424 in the second sensor 304. FIGS. 10A to 10C are diagrams illustrating changes in the outputs from the first light receiving part 422 and the second light receiving part 424 in three different states. FIG. 11 is a diagram illustrating output waveforms of the first light receiving part 422 and the second light receiving part 424 and an output waveform of the differential amplifier 432 in the case where a relative positional relationship between the second sensor 304 and the print medium M supported on the platen 218 is changed in the X direction. Note that, in FIGS. 9 to 11, the light emitting part 412 is arranged at a position away from the light receiving member 414 in the X direction to facilitate understanding.

In the differential mode, the first light receiving part 422 receives reflected light in a light reception region La1 from which the first light receiving part 422 can receive light, and outputs a voltage corresponding to an amount of light by converting the received light to the voltage. Moreover, in a differential mode, the second light receiving part 424 receives reflected light in a light reception region La2 from which the second light receiving part 424 can receive light, and outputs a voltage corresponding to an amount of light by converting the received light to the voltage. Note that the light reception region La1 and the light reception region La2 do not overlap each other in the X direction, and have the same area. Note that having the same area is not limited to having precisely the same area, and also includes the case where a difference between the areas of the two light reception regions La1 and La2 is within a predetermined range.

In the differential mode, the output voltages from the first light receiving part 422 and the second light receiving part 424 are inputted into the differential amplifier 432. In the differential amplifier 432, a difference between a voltage value VA outputted from the first light receiving part 422 and a voltage value VB outputted from the second light receiving part 424 is amplified, and a differential signal Vout is outputted. The light emitting part 412 emits light to the entire region in the light reception region La1 of the first light receiving part 422 and the entire region in the light reception region La2 of the second light receiving part 424.

Changes in the output waveforms of the first light receiving part 422 and the second light receiving part 424 in the differential mode are explained with reference to FIGS. 10A to 10C while focusing on one of the light receiving parts. FIGS. 10A to 10C illustrate the case where the second sensor 304 is moved relative to the print medium M supported on the platen 218 from the other side toward the one side in the X direction (−X direction), above the print medium M. In FIGS. 10A to 10C, the situation sequentially changes from the state illustrated in FIG. 10A to the state illustrated in FIG. 10B, and then to the state illustrated in FIG. 10C. In the case where the print medium M is located in the entire region of the light reception region La, the amount of received light in the light receiving part is maximized by the reflected light from the print medium M located in the light reception region La, and an output voltage of the light receiving part is maximized (see FIG. 10A).

In the case where the second sensor 304 is moved in the −X direction from the state of FIG. 10A and the platen 218 is located in the region within the light reception region La, the amount of reflected light from the light reception region La decreases as a proportion of an area occupied by the platen 218 increases in the region. Accordingly, the amount of received light in the light receiving part decreases in response to the movement of the second sensor 304, and the output voltage of the light receiving part gradually decreases (see FIG. 10B).

Then, in the case where the second sensor 304 is further moved in the −X direction from the state of FIG. 10B and no print medium M is located, that is only the platen 218 is located in the entire region within the light reception region La, almost no light is reflected from within the light reception region La. Accordingly, the output voltage of the light receiving part takes a minimum value (see FIG. 10C).

In the second sensor 304, the output voltages change as described above in the first light receiving part 422 and the second light receiving part 424. Note that, since the first light receiving part 422 and the second light receiving part 424 are provided at different positions in the X direction, positions where the output voltages change (output waveforms tilt) are shifted from each other in the X direction. Then, the output voltages of the first light receiving part 422 and the second light receiving part 424 are inputted into the differential amplifier 432. In the differential amplifier 432, a differential signal Vout is outputted based on a difference between the output voltage of the first light receiving part 422 and the output voltage of the second light receiving part 424. Accordingly, in the output waveform illustrating the changes in the differential signal Vout, a waveform with a predetermined shape is formed in a region where there is the difference between the output voltage of the first light receiving part 422 and the output voltage of the second light receiving part 424, that is near the end portion of the print medium M. The output waveform of the differential amplifier 432 is explained below with reference to FIG. 11.

Assume that the second sensor 304 is at a first position where the print medium M is located in the entire region of each of the light reception region La1 of the first light receiving part 422 and the light reception region La2 of the second light receiving part 424. In this case, the output voltage VA of the first light receiving part 422 and the output voltage VB of the second light receiving part 424 both take the maximum values and are the same value. Accordingly, at the first position, the difference between the output voltage VA and the output voltage VB is 0 V, and the differential signal Vout from the differential amplifier 432 is 0 V. Note that, in FIG. 11, a portion of the output waveform of the output voltage VA and a portion of the output waveform of the output voltage VB where the output voltages are the same are illustrated with a gap provided between the output waveforms to facilitate understanding.

In the case where the second sensor 304 moves from the other side toward the one side in the X direction (−X direction) from the first position, the second sensor 304 transitions to a second position. At the second position, the print medium M is located in the entire region of the light reception region La1 of the first light receiving part 422, and the platen 218 is located in part of the light reception region La2 of the second light receiving part 424. At the second position, there is a difference between the output voltage VA of the first light receiving part 422 and the output voltage VB of the second light receiving part 424. Specifically, the output voltage VA of the first light receiving part 422 is higher than the output voltage VB of the second light receiving part 424. More specifically, the output voltage VA of the first light receiving part 422 is maintained at the maximum value, while the output voltage VB of the second light receiving part 424 gradually decreases with the movement. Accordingly, at the second position, the difference between the output voltage VA and the output voltage VB gradually increases with the movement, and the differential signal Vout thereby increases.

Moreover, in the case where the second sensor 304 is further moved in the −X direction from the second position, the second sensor 304 transitions to a third position. At the third position, the print medium M is located in the entire region of the light reception region La1 of the first light receiving part 422, and the platen 218 is located in the entire region of the light reception region La2 of the second light receiving part 424. At the third position, the output voltage VA of the first light receiving part 422 maintains the maximum value, while the output voltage VB of the second light receiving part 424 reaches and maintains a minimum value. Accordingly, the difference between the output voltage VA and the output voltage VB is maximized, and the differential signal Vout takes a maximum value.

Then, in the case where the second sensor 304 is further moved in the −X direction from the third position, the second sensor 304 transitions to a fourth position. At the fourth position, the platen 218 is located in part of the light reception region La1 of the first light receiving part 422, and the platen 218 is located in the entire region of the light reception region La2 of the second light receiving part 424. At the fourth position, the output voltage VA of the first light receiving part 422 gradually decreases with the movement, while the output voltage VB of the second light receiving part 424 maintains the minimum value. Accordingly, at the fourth position, the difference between the output voltage VA and the output voltage VB gradually decreases with the movement, and the differential signal Vout thereby decreases.

Then, in the case where the second sensor 304 is further moved in the −X direction from the fourth position, the second sensor 304 transitions to a fifth position. At the fifth position, the platen 218 is located in the entire region of each of the light reception region La1 of the first light receiving part 422 and the light reception region La2 of the second light receiving part 424. At the fifth position, the output voltage VA of the first light receiving part 422 and the output voltage VB of the second light receiving part 424 both take the minimum values and are the same value. Accordingly, at the fifth position, the difference between the output voltage VA and the output voltage VB is 0 V, and the differential signal Vout from the differential amplifier 432 is 0 V.

A position P1 where the output Vout of the differential amplifier 432 exceeds a first threshold Th1 set in advance and a position P2 where the output Vout falls below the first threshold Th1 are detected for such changes in the output Vout, and a midpoint P0 of the positions P1 and P2 is obtained as the end portion position of the print medium M. Note that, for example, the first threshold Th1 as described above is determined through experiments depending on the type and the like of the print medium M to be used.

### Detection Operation in Single Mode

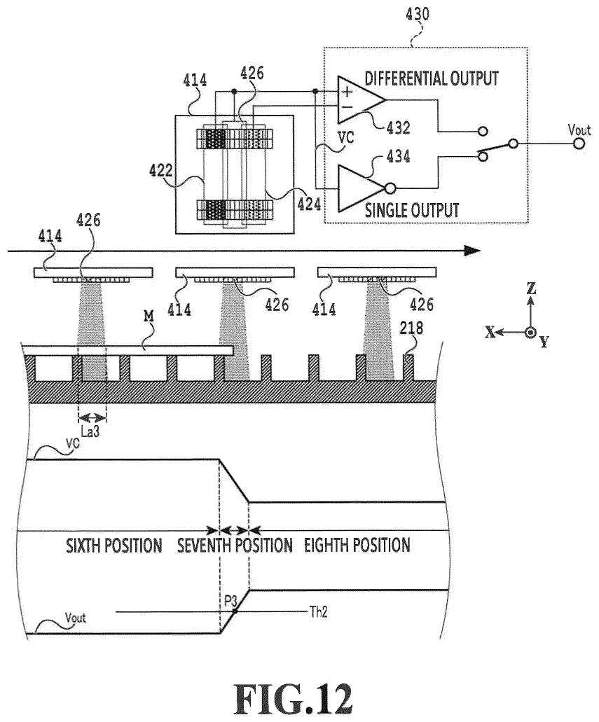

Next, an outline of a detection operation in the single mode is explained. FIG. 12 is a diagram illustrating an output waveform corresponding to changes in an output voltage VC of the third light receiving part 426 and an output waveform corresponding to changes in an output signal Vout of the single amplifier 434 in the case where a relative positional relationship between the second sensor 304 and the print medium M supported on the platen is changed in the X direction. Note that, in FIG. 12, the light emitting part 412 is omitted to facilitate understanding.

In the single mode, the third light receiving part 426 receives reflected light in a light reception region La3 from which the third light receiving part 426 can receive light, and outputs a voltage corresponding to an amount of light by converting the received light to the voltage. The output voltage from the third light receiving part 426 is inputted into the single amplifier 434, amplified and inverted in the single amplifier 434, and is outputted. The light emitting part 412 emits light to the entire region within the light reception region La3 of the third light receiving part 426.

Changes in the output waveform of the third light receiving part 426 and changes in the output waveform of the single amplifier 434 in the single mode are explained with reference to FIG. 12. FIG. 12 illustrates the case where the second sensor 304 is moved relative to the print medium M supported on the platen 218 from the other side toward the one side in the X direction (−X direction), above the print medium M.

Assume that the second sensor 304 is at a sixth position where the print medium M is located in the entire region of the light reception region La3 of the third light receiving part 426. In this case, the output voltage VC of the third light receiving part 426 takes a maximum value, and the output signal Vout based on this output voltage VC takes a minimum value.

In the case where the second sensor 304 is moved in the −X direction from the sixth position, the second sensor 304 transitions to a seventh position where the platen 218 is located in part of the light reception region La3 of the third light receiving part 426. At the seventh position, the amount of received light in the third light receiving part 426 decreases depending on a proportion of an area occupied by the platen 218 in the light reception region La3. Accordingly, at the seventh position, the output voltage VC of the third light receiving part 426 gradually decreases with the movement. The output signal Vout thereby gradually increases in response to the change in the output voltage VC.

Then, in the case where the second sensor 304 is further moved in the −X direction from the seventh position, the second sensor 304 transitions to an eighth position where the platen 218 is located in the entire region of the light reception region La3 of the third light receiving part 426. At the eighth position, almost no light is reflected from the light reception region La3, and the amount of received light in the third light receiving part 426 is minimized. Accordingly, at the eighth position, the output voltage VC of the third light receiving part 426 takes a minimum value, and the output signal Vout based on the output voltage VC takes a maximum value.

Then, a position P3 where the output signal Vout of the single amplifier 434 passes a second threshold Th2 set in advance is detected for such changes in the output signal Vout based on the output voltage VC of the third light receiving part 426, and this position P3 is obtained as the end portion position of the print medium M. Note that, for example, the second threshold Th2 as described above is determined through experiments depending on the type and the like of the print medium M to be used.

### <Output Adjustment by Adjusting Part>

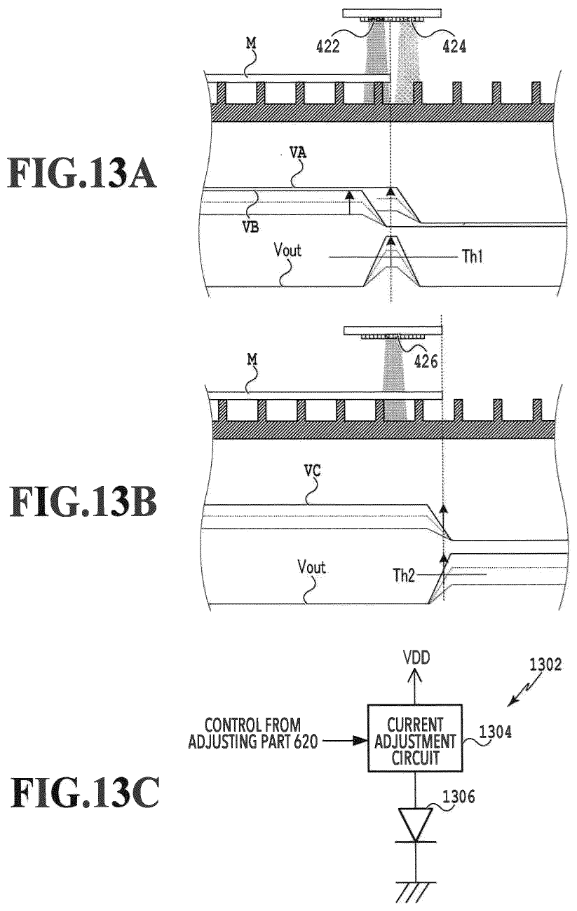

Next, output adjustment by the adjusting part 620 (see FIG. 6) is explained. FIGS. 13A to 13C are diagrams explaining the output adjustment by the adjusting part 620, FIGS. 13A and 13B are diagrams explaining output adjustment of the output switching amplifier 430, and FIG. 13C is a diagram explaining output adjustment of the light emitting parts 402 and 412.

First, an outline of an adjustment operation of the output of the output switching amplifier 430 is explained. In the differential mode, the second sensor 304 is moved to a position where the end portion of the print medium M is located between the first light receiving part 422 and the second light receiving part 424 of the second sensor 304. Then, at this position, there is obtained the differential signal Vout outputted from the differential amplifier 432 based on the difference between the output voltage VA from the first light receiving part 422 and the output voltage VB from the second light receiving part 424. The adjusting part 620 adjusts the output of the output switching amplifier 430 such that the differential signal Vout in this case sufficiently exceeds the first threshold Th1.

In the single mode, the second sensor 304 is moved to a position where the print medium M is located in the entire region of the light reception region La3 of the third light receiving part 426 in the second sensor 304. Then, at this position, there is obtained the output signal Vout outputted from the single amplifier 434 based on the output voltage VC from the third light receiving part 426. The adjusting part 620 adjusts the output of the output switching amplifier 430 such that the output signal Vout in this case sufficiently exceeds the second threshold Th2.

Next, the output adjustment of the light emitting parts 402 and 412 are explained. The adjusting part 620 adjusts the light emission amount of each of the light emitting part 402 and the light emitting part 412 via a light emission amount adjustment circuit 1302. Specifically, in each of the light emitting parts 402 and 412, the light emission amount is adjusted as follows. A current adjustment circuit 1304 adjusts a current amount by being controlled by the adjusting part 620, and a current adjusted in the current adjustment circuit 1304 is supplied to a LED light source 1306. As described above, in the present embodiment, the adjusting part 620 adjusts the output from the output switching amplifier 430 based on the output of the second sensor 304, by using the light emission amount of the light emitting part, the amplification factor of the output switching amplifier 430, and the like.

### <Outline of Printing Operation>

In the above-mentioned configuration, the printing apparatus 10 performs printing on the print medium M based on a print job. In the following explanation, a case where the printing apparatus 10 performs bidirectional printing in a forward direction (+X direction) from the one side toward the other side in the X direction and a backward direction (−X direction) from the other side toward the one side in the X direction is explained as an example. Moreover, the printing apparatus 10 repeatedly executes scanning involving printing by the print head 12 multiple times while changing the position in the conveyance direction (Y direction) of the print medium to print an image based on the print data on the print medium M. Moreover, in the printing apparatus 10, it is possible to selectively execute a margin printing in which there is a margin around a print image and a micro-margin printing in which printing is performed very close to the end portions of the print medium to obtain visual effects equivalent to marginless printing in which there is no margin around the print image. Specifically, in the present embodiment, the margin printing is printing in which visible margins are provided in the end portions of the print medium, and the micro-margin printing is printing in which no margins are provided in the end portions of the print medium or printing in which margins less likely to be visually recognized are provided in the end portions of the print medium.

The main controller 600 controls the conveyance by the conveyance part 202, the ink ejection from the print head 12, the movement of the carriage 216, and the like to execute the margin printing and the micro-margin printing. As described above, in the present embodiment, the main controller 600 functions as a print control part capable of selectively executing the margin printing and the micro-margin printing.

### =Micro-Margin Printing=

First, an outline of a printing operation in the micro-margin printing is explained. FIGS. 14A to 14L are diagrams explaining the outline of the printing operation in the micro-margin printing. In the case where the micro-margin printing is started, the ink is ejected from the print head 12 while the carriage 216 at the standby position (see FIG. 14A) is moved in the forward direction, and the scanning involving printing is started (see FIG. 14B). As described in detail later, the printing start position in the X direction in this case is obtained before the printing, and is a position matching an end portion ER of the print medium M on the one side or a position in the print medium M that is slightly inside (for example, about 0.5 mm) the end portion ER. During this scanning involving printing in which the carriage 216 is moved in the forward direction, the second sensor 304 monitors an end portion EL of the print medium M on the other side. Then, in the case where the second sensor 304 passes the end portion EL, that is detects the end portion EL, the position coordinate obtaining part 618 obtains the position of the end portion EL based on a result of this detection (see FIG. 14C). Then, in the case where the scanning involving printing is completed, the carriage 216 stops (see FIG. 14D). Thereafter, the conveyance part 202 conveys the print medium M by a predetermined amount in the +Y direction (see FIG. 14E). Note that, in the case where the position of the end portion EL is obtained, in the main controller 600, the printing start position in the X direction in the next scanning involving printing is determined based on the obtained position of the end portion EL.

In the case where the scanning involving printing in the forward direction is completed, next, the ink is ejected from the print head 12 while the carriage 216 at the stop position on the other side of a movement region of the carriage 216 (see FIG. 14F) is moved in the backward direction, and the next scanning involving printing is started (see FIG. 14G). In this scanning involving printing, the print image is formed from the printing start position determined based on the detection result of the second sensor 304 in the previous scanning involving printing in the forward direction. During this scanning involving printing in which the carriage 216 is moved in the backward direction, the first sensor 302 monitors the end portion ER of the print medium Mon the one side. Then, in the case where the first sensor 302 passes the end portion ER, that is detects the end portion ER, the position coordinate obtaining part 618 obtains the position of the end portion ER based on a result of this detection (see FIG. 14H). Then, in the case where the scanning involving printing is completed, the carriage 216 stops (see FIG. 14I). Thereafter, the conveyance part 202 conveys the print medium M by a predetermined amount in the +Y direction (see FIG. 14J). Note that, in the case where the position of the end portion ER is obtained, in the main controller 600, the printing start position in the X direction in the next scanning involving printing is determined based on the obtained position of the end portion ER. Specifically, a position obtained by correcting the obtained position information of the end portion ER with a correction value (see S1622 to be described later) is set as this printing start position.

Then, the ink is ejected from the print head 12 while the carriage 216 at the stop position on the one side of the movement region of the carriage 216 (see FIG. 14K) is moved in the forward direction, and the next scanning involving printing is executed (see FIG. 14L). In this scanning involving printing, the print image is formed from the printing start position determined based on the detection result of the first sensor 302 in the previous scanning involving printing in the backward direction. The printing apparatus 10 executes the printing on the print medium M by repeatedly, alternately executing the scanning involving printing in the forward direction and the scanning involving printing in the backward direction as described above. In the micro-margin printing, the printing start position in the scanning involving printing is a position determined based on the end portion of the print medium obtained in the immediately-previous scanning involving printing. As described above, in the micro-margin printing, the printing is performed such that the printing region is changeable depending on the position information of the end portion of the print medium in the printing.

### =Margin Printing=

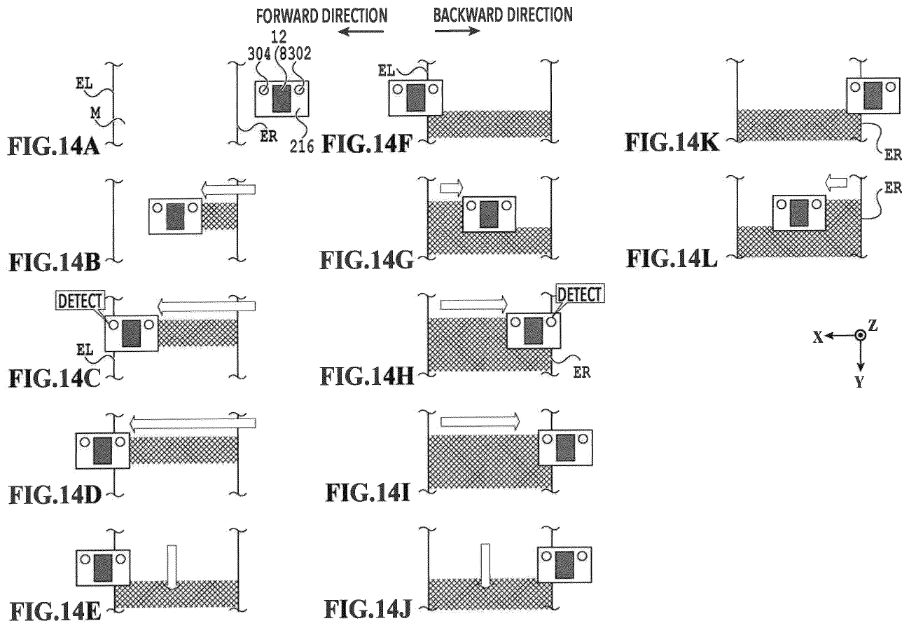

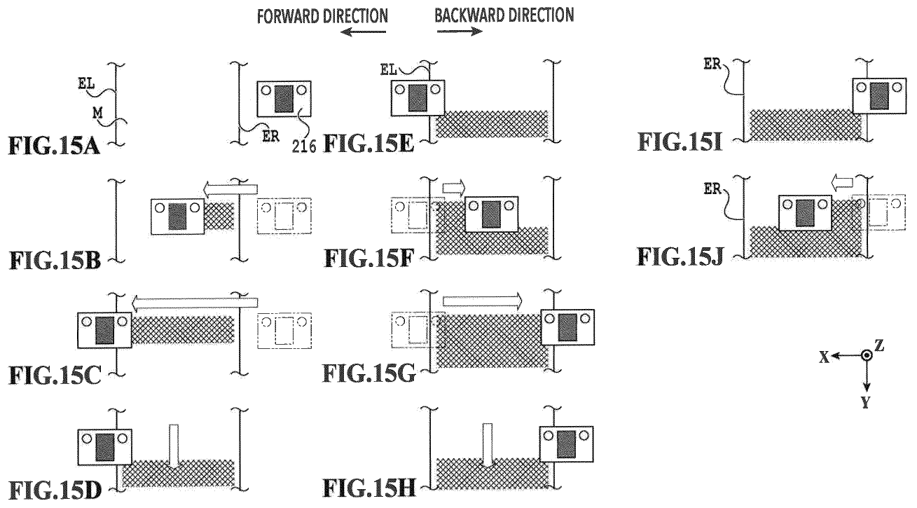

Next, an outline of a printing operation in the margin printing is explained. FIGS. 15A to 15J are diagrams explaining the outline of the printing operation in the margin printing. In the case where the margin printing is started, the ink is ejected from the print head 12 while the carriage 216 at the standby position (see FIG. 15A) is moved in the forward direction, and the scanning involving printing is started (see FIG. 15B). As described in detail later, in this scanning involving printing, printing is started from the printing start position set based on the position information of the end portion (ER) of the print medium M before the printing in the X direction. This printing start position is a position in the print medium M that is inside the end portion ER of the print medium M by a predetermined amount (for example, about 5 mm). Then, in the case where this scanning involving printing is completed, the carriage 216 stops (see FIG. 15C). Thereafter, the conveyance part 202 conveys the print medium M by a predetermined amount in the +Y direction (see FIG. 15D).

In the case where the scanning involving printing in the forward direction is completed, next, the ink is ejected from the print head 12 while the carriage 216 at the stop position on the other side of the movement region of the carriage 216 (see FIG. 15E) is moved in the backward direction, and the next scanning involving printing is started (see FIG. 15F). In this scanning involving printing, printing is started from the printing start position set in advance in the X direction. This printing start position is set based on position information of the end portion of the print medium M before printing and information on the width of the print medium M included in the print job. The printing start position is a position in the print medium M that is inside the end portion EL of the print medium M by a predetermined amount (for example, about 5 mm). Then, in the case where this scanning involving printing is completed, the carriage 216 stops (see FIG. 15G). Thereafter, the conveyance part 202 conveys the print medium M by a predetermined amount in the +Y direction (see FIG. 15H).

Then, the ink is ejected from the print head 12 while the carriage 216 at the stop position on the one side of the movement region of the carriage 216 (see FIG. 15I) is moved in the forward direction, and the next scanning involving printing is executed (see FIG. 15J). The printing apparatus 10 executes the printing on the print medium M by repeatedly, alternately executing the scanning involving printing in the forward direction and the scanning involving printing in the backward direction as described above. In the margin printing, the printing start position in the scanning involving printing is a position obtained in a later-described adjustment process executed before the printing.

### <Adjustment Process>

In the case where the micro-margin printing or the margin printing described above is to be executed, the printing apparatus 10 executes the adjustment process in which the output adjustment of the first sensor 302 and the second sensor 304 is performed before the execution of the actual printing operation. Specifically, in the case where the execution of the printing process based on the print job is instructed, the printing apparatus 10 executes the adjustment process, and then executes the printing process based on the print job. Note that, as described above, since the margin amount in printing is set to 0 mm or about 0.5 mm in the micro-margin printing, high accuracy is required in the detection of the end portions of the print medium M. Meanwhile, since the margin amount in the printing is about 5 mm in the margin printing, high accuracy is not required in the detection of the end portions of the print medium M. Accordingly, in this adjustment process, the output adjustment of the first sensor 302 and the second sensor 304 is executed depending on the accuracy required in the printing to be executed.

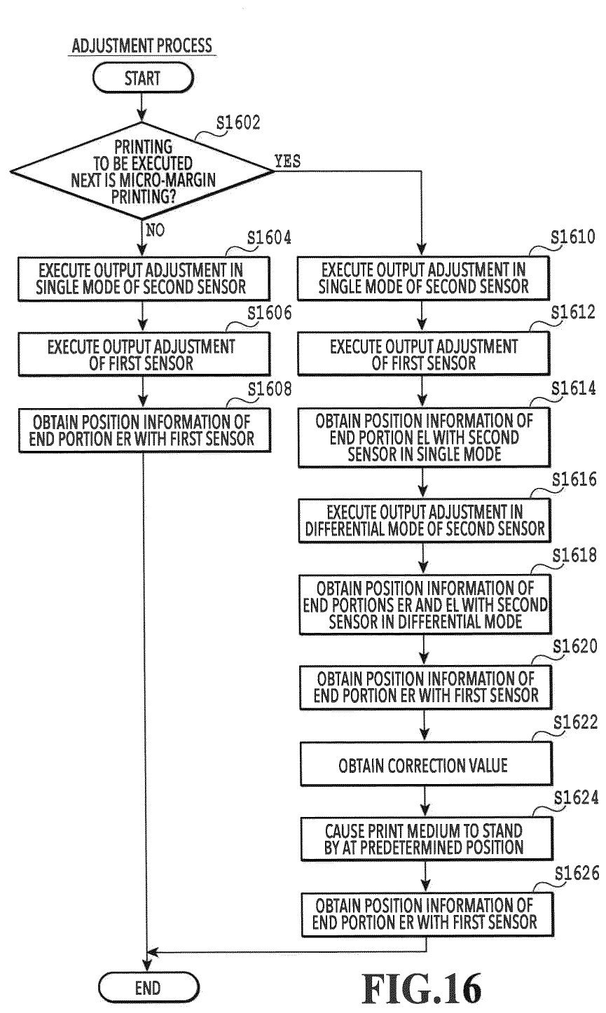

FIG. 16 is a flowchart illustrating details of the adjustment process in which the output adjustment of the first sensor 302 and the second sensor 304 are performed. The main controller 600 performs a series of processes illustrated in the flowchart of FIG. 16 by expanding program codes stored in the flash ROM 602 on the RAM 604 and executing the program codes. Alternatively, some or all of functions of steps in FIG. 16 may be executed by hardware such as an ASIC or an electric circuit. In the present specification, sign S in explanation of each process in the flowchart means step in this flowchart. Moreover, in the following explanation of the adjustment process, a case where the sheet-shaped print medium MR unwound and conveyed from the roll R is conveyed is explained as an example.

In the case where the adjustment process is started, first, in S1602, the main controller 600 determines whether the printing to be executed next is the micro-margin printing or not. In S1602, the main controller 600 determines whether the type of the printing set in the print job is the micro-margin printing or not. If the main controller 600 determines that the type of the printing set in the print job is the margin printing, that is the printing to be executed next is not the micro-margin printing in S1602, the process proceeds to S1604. In S1604, the main controller 600 executes the output adjustment in the single mode of the second sensor 304. Specifically, in S1604, first, the conveyance part 202 conveys the print medium MR unwound from the roll R to an adjustment position where, for example, a leading edge of the print medium MR is located downstream of the movement region of the carriage 216 in the +Y direction. The adjustment position may be any position as long as it is a position where the first sensor 302 and the second sensor 304 can detect the end portions of the print medium MR in the X direction in the case where the carriage 216 is reciprocally moved in the X direction. Then, in S1604, the output adjustment in the single mode of the second sensor 304 is executed. Specifically, the adjustment is performed such that the output signal Vout on the print medium M sufficiently exceeds the threshold Th2. Note that, in the output adjustment of the second sensor 304, the adjusting part 620 adjusts the light emission amount of the light emitting part 412 and the amplification factor of the output switching amplifier 430. Moreover, various publicly-known techniques such as, for example, the output adjustment method disclosed in Japanese Patent Laid-Open No. 2004-182361 may be used for the output adjustment of the second sensor 304.

In S1604, since the printing to be executed next is the margin printing and the obtaining of the position information with high accuracy is unnecessary, only the output adjustment in the single mode is executed in which the output adjustment can be executed by performing a relatively simple operation for the second sensor 304. If the output adjustment in the differential mode of the second sensor 304 were executed in S1604, the output adjustment in the single mode and the output adjustment in the differential mode would need to be executed (see S1612 to S1616 to be described later), and the output adjustment of the sensor would take time. Accordingly, in S1604, only the output adjustment in the single mode of the second sensor 304 is executed based on a level of detection accuracy required in the margin printing. This reduces the time period required for the process of S1604. As a result, the time period required for the adjustment process in the execution of the margin printing is reduced, and smooth transition to the printing process becomes possible.

Next, in S1606, the main controller 600 executes the output adjustment of the first sensor 302. Specifically, in S1606, the adjusting part 620 adjusts the light emission amount of the light emitting part 402 and the amplification factor of the amplifier (not illustrated) configured to amplify the output of the light receiving part 404. Note that various publicly-known techniques such as, for example, the output adjustment method disclosed in Japanese Patent Laid-Open No. 2004-182361 may be used for the output adjustment of the first sensor 302. Then, in S1608, the main controller 600 detects the end portion ER of the print medium MR on the one side in the X direction with the first sensor 302 to obtain the position information of the end portion ER, and terminates this adjustment process. In S1608, the position information of the end portion ER is obtained based on the detection result of the end portion ER obtained by the first sensor 302 in the case where the carriage 216 is moved in, for example, the backward direction. In the case where the adjustment process is completed, the printing process in which the margin printing is performed based on the print job is executed. In this printing process, the position information of the end portion ER obtained in S1608 is used as a reference value of the printing start position in the execution of the scanning involving printing in the forward direction. Note that the printing start position in the execution of the scanning involving printing in the backward direction is determined based on, for example, the printing start position in the forward direction, the size of the image data to be printed in the X direction, and the like. As described above, in the margin printing, the printing is executed with the printing region fixed based on the position information of the end portion of the print medium before the printing. In the present embodiment, the main controller 600: functions as a setting part configured to set the reference value of the printing start position in the execution of the scanning involving printing.

Moreover, if the main controller 600 determines that the type of printing set in the print job is the micro-margin printing, that is printing to be executed next is the micro-margin printing, the process proceeds to S1610. In S1610, the main controller 600 executes the output adjustment in the single mode of the second sensor 304. Then, in S1612, the main controller 600 executes the output adjustment of the first sensor 302. Specific details of processes of S1610 and S1612 are the same as those of S1604 and S1606.

Next, in S1614, the main controller 600 detects the end portion EL of the print medium MR on the other side in the X direction with the second sensor 304 in the single mode to obtain the position information of the end portion EL. In S1614, the position information of the end portion EL is obtained based on the detection result of the end portion EL obtained by the second sensor 304 in the case where the carriage 216 is moved in, for example, the forward direction. Then, in S1616, the main controller 600 executes the output adjustment in the differential mode of the second sensor 304. Specifically, in S1616, the carriage 216 is moved such that the optical center of the second sensor 304 is arranged at a position corresponding to the position information of the end portion EL obtained in S1614. Then, the output adjustment in the differential mode of the second sensor 304 is performed such that the differential signal Vout takes a value sufficiently exceeding the threshold Th1 in this state. The second sensor 304 can thereby obtain the position information of the end portions ER and EL of the print medium MR with high accuracy.

Thereafter, in S1618, the main controller 600 obtains the position information of the end portions ER and EL of the print medium MR with the second sensor 304 in the differential mode. In S1618, the position information of the end portion EL is obtained based on the detection result of the end portion EL in the case where, for example, the carriage 216 is moved in the forward direction. Moreover, in S1618, the position information of the end portion ER is obtained based on the detection result of the end portion ER in the case where, for example, the carriage 216 is moved in the backward direction. Next, in S1620, the main controller 600 obtains the position information of the end portion ER of the print medium MR with the first sensor 302. In S1620, the position information of the end portion ER is obtained based on the detection result of the end portion ER in the case where, for example, the carriage 216 is moved in the backward direction.

Then, in S1622, the main controller 600 obtains a correction value for correcting the position information obtained based on the detection result of the first sensor 302, based on the position information of the end portion ER obtained in S1620 and the position information of the end portion ER obtained in S1618. Specifically, in S1622, there is obtained a correction value that approximates the position information based on the detection result of the first sensor 302 which is relatively inaccurate, to the position information based on the detection result in the differential mode of the second sensor 304 which is relatively accurate. Specifically, in S1622, a difference between the position information of the end portion ER obtained in S1618 and the position information of the end portion ER obtained in S1620 is obtained, and the obtained value is obtained as the correction value for correcting the position information based on the detection result of the first sensor 302. Note that the obtained correction value is stored in, for example, a storage region of the printing apparatus 10 such as the RAM 604. Correcting the position information obtained based on the detection result of the first sensor 302 with this correction value can approximate this position information to the position information obtained based on the detection result of the second sensor 304 having a detection performance with higher accuracy. As described above, in the present embodiment, the main controller 600 has a function as a correction value obtaining part configured to obtain the correction value for correcting the position information of the end portion of the print medium.

Next, in S1624, the main controller 600 detects the leading edge portion of the print medium MR in the conveyance direction with the first sensor 302, and causes the print medium MR to stand by at a predetermined position. Specifically, in S1624, first, the carriage 216 is moved to a position where the first sensor 302 is located on the conveyed print medium MR. Thereafter, the conveyance part 202 conveys the print medium MR in the −Y direction while the roll holding part 22 rewinds the roll R. In this conveyance of the print medium MR in the −Y direction, the first sensor 302 detects the position of the leading edge portion of the print medium MR located downstream in the +Y direction. Then, the leading edge portion is conveyed in the −Y direction by a predetermined amount from the position where the leading edge portion is detected, and the print medium MR is made to stand by at the predetermined position. The predetermined position is, for example, a position where the leading edge portion of the print medium MR is located downstream of the first sensor 302 in the +Y direction.

Thereafter, in S1626, the first sensor 302 obtains the position information of the end portion ER of the print medium MR, and this adjustment process is terminated. In S1626, for example, the position information of the end portion ER is obtained based on the detection result of the end portion ER in the case where, for example, the carriage 216 is moved in the backward direction. In the case where the adjustment process is completed, the printing process in which the micro-margin printing is performed based on the print job is executed. Note that, in this printing process, the position information obtained by correcting the position information of the end portion ER obtained in S1626 with the correction value obtained in S1622 is used as the printing start position in execution of the first scanning involving printing. Accordingly, in the scanning involving printing, there is used the position information expected to have higher accuracy than the position information of the end portion ER obtained simply based on the detection result of the first sensor 302.

### Modification

Although the printing apparatus 10 determines whether the printing to be executed next is the micro-margin printing or the margin printing and executes the output adjustment of the first sensor 302 and the second sensor 304 based on this determination in the adjustment process in the above-mentioned explanation, the present disclosure is not limited to this. In the adjustment process, the output adjustment of the sensors to be used in the printing operation may be executed depending on various types of printing. Specifically, assume that the printing apparatus 10 executes first printing in which printing is performed by using position information of the end portions of the print medium M obtained by a predetermined sensor and second printing in which printing is performed by using prim medium spatial coordinate information for determining a printing region that is obtained by a sensor different from the predetermined sensor. In this case, the printing apparatus 10 executes the output adjustment of the predetermined sensor in the case where the first printing is to be executed, and executes the output adjustment of the sensor different from the predetermined sensor in the case where the second printing is to be executed.

In the above-mentioned explanation, the leading edge portion of the print medium MR stands by at the predetermined position downstream of the first sensor 302 in the +Y direction in S1624 of the adjustment process. However, the present disclosure is not limited to this. The predetermined position may be such a position that the leading edge portion of the print medium MR is located upstream of the first sensor 302 in the +Y direction. In this case, for example, the configuration may be such that the first sensor 302 obtains the position information of the end portion ER after the obtaining of the correction value in S1622, and then the print medium MR is made to stand by at the above-mentioned predetermined position.

In the above-mentioned explanation, in the case where the margin printing is to be executed, the first sensor 302 obtains the position information of the end portion ER in S1608. However, the present disclosure is not limited to this. Specifically, in S1608, for example, the second sensor 304 in the single mode may obtain the position information of the end portion ER.

In the above-mentioned explanation, in the margin printing, the printing is performed by using the position information obtained by the first sensor 302. However, the present disclosure is not limited to this. For example, the configuration may be such that the position information of the end portions of the print medium M is obtained or estimated based on various publicly-known techniques.

In the above-mentioned explanation, in the micro-margin printing, the printing is performed by using the first sensor 302 and the second sensor 304. However, the present disclosure is not limited to this. For example, the end portion ER and the end portion EL of the print medium M may be detected by using only the second sensor 304. Alternatively, a publicly-known technique that enables obtaining of the position information of the end portions ER and EL in the scanning involving printing or a publicly-known technique that enables estimation of the position information by using various pieces of information may be used.

### Operations and Effects

As explained above, the printing apparatus 10 according to the present embodiment executes the output adjustment of the first sensor 302 and the second sensor 304 depending on the type of printing to be executed in the printing process, before execution of the printing process. Specifically, in the case where printing (margin printing) in which the printing region is fixed based on the position information of the end portions of the print medium before the printing is to be executed, the printing apparatus 10 omits execution of the output adjustment in the differential mode of the second sensor 304 in which highly-accurate position information can be obtained. Meanwhile, in the case where printing (micro-margin printing) in which the printing region is changeable based on the position information of the end portions of the print medium during the printing is to be executed, the printing apparatus 10 executes the output adjustment of each sensor including the output adjustment in the differential mode of the second sensor 304 in which highly-accurate position information can be obtained.

This allows transition to the printing process while securing the detection accuracy depending on the type of printing to be executed next, in the adjustment process after the instruction of start of the printing process based on the print job. Accordingly, in the case where printing that does not require highly-accurate position information obtained by various sensors such as margin printing is to be executed, smooth transition to the printing process is executed after the instruction of start of the printing process. Thus, a time period required for the printing is reduced.

### Second Embodiment

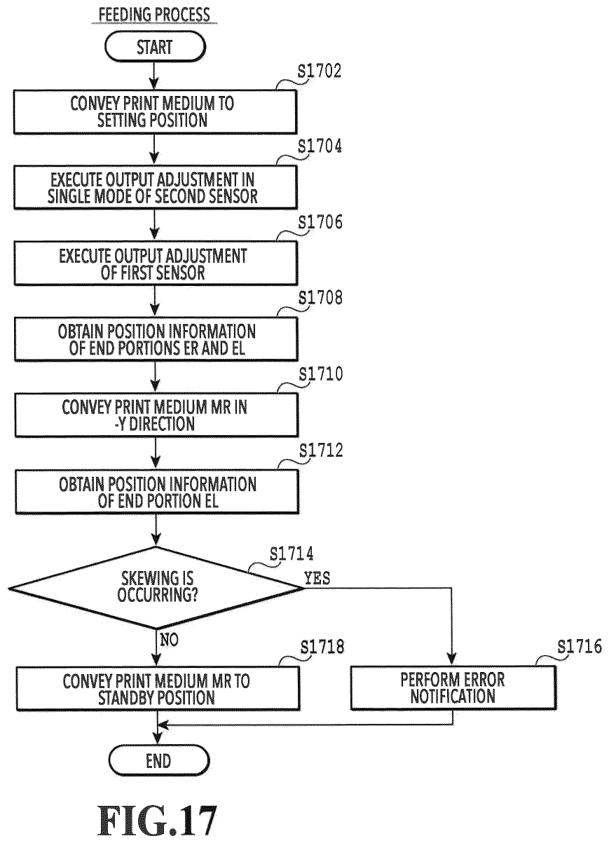

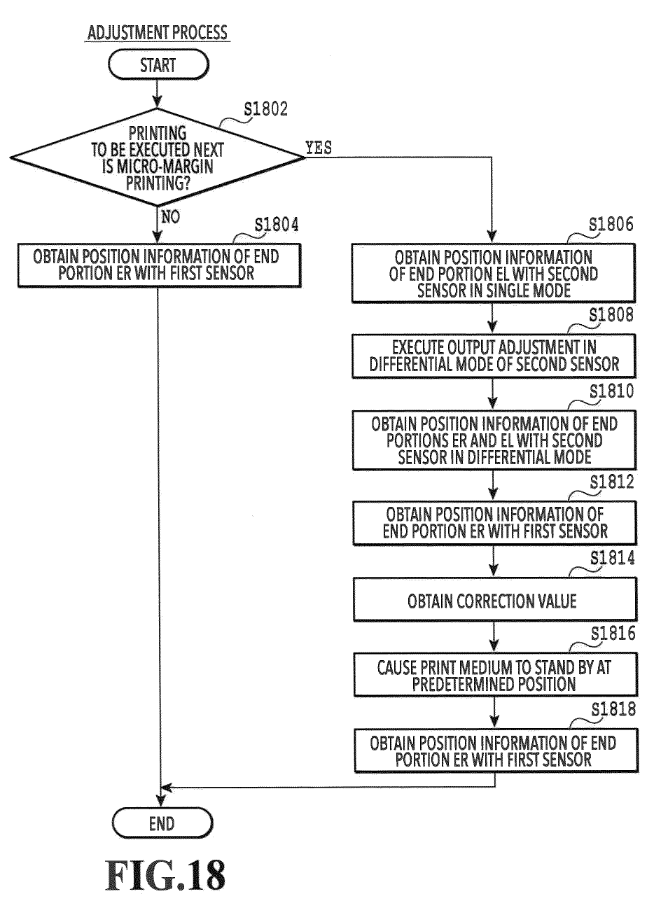

Next, a printing apparatus according to a second embodiment is explained with reference to FIGS. 17 and 18. In the following explanation, configurations identical or corresponding to the configurations of the printing apparatus according to the first embodiment described above are denoted by the same reference numerals as the reference numerals used in the first embodiment, and detailed explanation thereof is omitted.

The second embodiment is different from the first embodiment described above in that a feeding process is executed, for example, after replacement of the roll R in the roll holding part 22. In the feeding process, the print medium MR is fed such that the print medium MR can be conveyed with skewing suppressed. Note that, in the case where the feeding process is completed, the printing apparatus 10 goes into a standby state until an instruction to start the printing according to the print job is given. In the case where this instruction is given, the printing apparatus 10 executes the adjustment process, and then executes the printing process in which the printing is performed based on the print job. The feeding process and the adjustment process after execution of the feeding process are explained below in detail. Note that, in the following explanation of the feeding process and the adjustment process, a case where the sheet-shaped print medium MR unwound and conveyed from the roll R is conveyed is explained as an example.

### <Feeding Process>

FIG. 17 is a flowchart illustrating details of the feeding process in which the print medium MR is fed such that the print medium MR can be conveyed with skewing suppressed. The main controller 600 performs a series of processes illustrated in the flowchart of FIG. 17 by expanding program codes stored in the flash ROM 602 on the RAM 604 and executing the program codes. Alternatively, some or all of functions of steps in FIG. 17 may be executed by hardware such as an ASIC or an electric circuit.

In the case where the feeding process is started, first, in S1702, the main controller 600 causes the conveyance part 202 to convey the print medium MR unwound from the roll R such that the leading edge of the print medium MR is at a setting position located downstream of the movement region of the carriage 216 in the +Y direction. This setting position may be any position as long as it is a position where the first sensor 302 and the second sensor 304 can detect the end portions of the print medium MR in the X direction in the case where the carriage 216 is reciprocally moved in the X direction. Moreover, the setting position may be the same as or different from the adjustment position described above.

Then, in S1704, the main controller 600 executes the output adjustment in the single mode of the second sensor 304. In a stage in which this feeding process is executed, what kind of printing is to be executed is yet to be determined, and the detection of the position information with high accuracy may become unnecessary. Accordingly, in the feeding process, only the output adjustment in the single mode in which the output adjustment can be executed in a relatively simple operation is executed for the second sensor 304. If the output adjustment were executed in the differential mode of the second sensor 304 in S1704, the output adjustment in the single mode and the output adjustment in the differential mode would need to be executed (see S1612 to S1616 described above), and the output adjustment of the sensor would take time. Accordingly, in S1704, only the output adjustment in the single mode of the second sensor 304 is executed to reduce a time period required for the process, and as a result, a time period required for the feeding process is reduced.

Next, in S1706, the main controller 600 executes the output adjustment of the first sensor 302. Thereafter, in S1708, the main controller 600 moves the carriage 216 in the forward direction and the backward direction in the X direction, obtains the position information of the end portions ER and EL of the print medium MR, and calculates the length of the print medium MR in the X direction. In S1708, the main controller 600 detects the end portion EL in the single mode of the second sensor 304 in the case where the carriage 216 is moved in the forward direction, and obtains the position information of the end portion EL. Moreover, in S1708, the main controller 600 detects the end portion ER with the first sensor 302 in the case where the carriage 216 is moved in the backward direction, and obtains the position information of the end portion ER. Note that, in S1708, the main controller 600 may obtain the position information of both of the end portions ER and EL with the first sensor 302 or the second sensor 304.

Thereafter, in S1710, the main controller 600 conveys the print medium MR at the setting position, by a predetermined amount in the −Y direction. Then, in S1712, the main controller 600 moves the carriage 216 to obtain the position information of the end portion EL with the first sensor 302 or the second sensor 304. In S1712, the main controller 600 obtains the position information of the end portion EL of the print medium MR at the position where it is moved by the predetermined amount in the −Y direction from the setting position, by using the first sensor 302 or the second sensor 304 used to obtain the position information of the end portion EL in S1708. Accordingly, the above-mentioned setting position is a position taking the conveyance amount in the −Y direction in S1710 into consideration such that the sensor can detect the end portion EL of the print medium MR in the movement of the carriage 216 also after the conveyance in the −Y direction in S1710.

Next, in S1714, the main controller 600 determines whether skewing is occurring in the conveyance of the print medium MR or not. In S1714, the main controller 600 obtains a difference between the position information of the end portion EL obtained in S1712 and the position information of the end portion EL obtained in S1708, and determines whether this difference exceeds a threshold set in advance. If the difference exceeds the threshold, the main controller 600 determines that skewing is occurring in the conveyance of the print medium MR. If the difference is equal to or smaller than the threshold, the main controller 600 determines that no skewing is occurring in the conveyance of the print medium MR. The threshold used in S1714 is, for example, a value corresponding to a skewing amount allowable in the micro-margin printing, and is determined through experiments based on, for example, the margin amount set in the micro-margin printing, the predetermined amount (conveyance amount in-Y direction) in S1710, and the like. As described above, in the present embodiment, the main controller 600 functions as a skewing detection part configured to detect skewing occurring in the conveyance of the print medium by the conveyance part 202.

If the main controller 600 determines that skewing is occurring in the conveyance of the print medium MR in S1714, the process proceeds to S1716, the main controller 600 performs error notification indicating that skewing is occurring in the conveyance of the print medium MR, and terminates this feeding process. In this case, the main controller 600 also performs notification prompting the user to retry the feeding process for the print medium MR unwound from the roll R held in the roll holding part 22. The user is notified of the error notification and the notification prompting the user to retry the feeding process, via the operation part 16, the notification part 18, and the like. Moreover, if the main controller 600 determines that no skewing is occurring in the conveyance of the print medium MR in S1714, the process proceeds to S1718, the main controller 600 moves the print medium MR to the standby position where the print medium MR stands by after the feeding, and terminates this feeding process. At the standby position, the print medium MR can be conveyed by the conveyance part 202.

### <Adjustment Process>

Next, the adjustment process executed after the feeding process is exampled. In the case where start of printing based on the print job is instructed, the printing process is started after execution of the adjustment process. Note that, in the present embodiment, the output adjustment in the single mode of the second sensor 304 and the output adjustment of the first sensor 302 are executed in the feeding process. Accordingly, these processes are omitted in the adjustment process. The adjustment process executed in the printing apparatus 10 of the present embodiment is explained below in detail with reference to FIG. 18.

FIG. 18 is a flowchart illustrating details of the adjustment process executed in the printing apparatus according to the present embodiment. The main controller 600 performs a series of processes illustrated in the flowchart of FIG. 18 by expanding program codes stored in the flash ROM 602 on the RAM 604 and executing the program codes. Alternatively, some or all of functions of steps in FIG. 18 may be executed by hardware such as an ASIC or an electric circuit.

In the case where the adjustment process is started, first, in S1802, the main controller 600 determines whether the printing to be executed next is the micro-margin printing or not. Specific details of a process of S1802 are the same as those of S1602. [If the main controller 600 determines that the printing to be executed next is not the micro-margin printing in S1802, the process proceeds to S1804. In S1804, the main controller 600 detects the end portion ER of the print medium MR on the one side in the X direction with the first sensor 302 to obtain the position information of the end portion ER, and terminates this adjustment process. Specific details of the process of S1804 are the same as those of S1608.

Moreover, if the main controller 600 determines that the printing to be executed next is the micro-margin printing in S1802, the process proceeds to S1806, and the main controller 600 obtains the position information of the end portion EL of the print medium MR with the second sensor 304 in the single mode. Then, in S1808, the main controller 600 executes the output adjustment in the differential mode of the second sensor 304. Next, in S1810, the main controller 600 obtains the position information of the end portions ER and EL of the print medium MR with the second sensor 304 in the differential mode. Then, in S1812, the main controller 600 obtains the position information of the end portion ER of the print medium MR with the first sensor 302.

Thereafter, in S1814, the main controller 600 obtains the correction value for correcting the position information obtained based on the detection result of the first sensor 302, based on the position information of the end portion ER obtained in S1812 and the position information of the end portion ER obtained in S1810. Then, in S1816, the main controller 600 causes the print medium MR to stand by at the predetermined position. Furthermore, in S1818, the main controller 600 obtains the position information of the end portion ER of the print medium MR with the first sensor 302, and terminates the adjustment process. Since specific details of processes of S1806 to S1818 are the same as those of S1614 to S1626 described above, detailed explanation thereof is omitted.

In the case where the adjustment process is executed via the feeding process as described above, the output adjustment in the single mode of the second sensor 304 and the output adjustment of the first sensor 302 are executed in the feeding process. Accordingly, these processes executed in the adjustment process in the first embodiment are omitted. Specifically, in the case where the margin printing is to be executed, the processes of S1604 to S1606 in the adjustment process of the first embodiment executed without the feeding process are omitted. Moreover, in the case where the micro-margin printing is executed, the processes of S1610 and 1612 in the adjustment process of the first embodiment executed without the feeding process are omitted. This can further reduce the time period required for the adjustment process, and smoother transition to the printing process can be achieved.

### Modification

In the above-mentioned explanation, in S1708 to S1714, skewing occurring in the conveyance of the print medium MR is detected based on the positions of the end portion ER before and after the movement of the print medium MR in the −Y direction. However, the present disclosure is not limited to this. For example, the leading edge portion (downstream end portion in the +Y direction) of the print medium MR in the conveyance direction is conveyed to a position where the leading edge portion is detectable by the first sensor 302, and then the carriage 216 is moved in the X direction to detect the leading edge portion at predetermined intervals. Then, in the case where a detection position where the leading edge portion is not detected is present in the detection of the first sensor 302, the main controller 600 determines that skewing is occurring in the conveyance of the print medium MR.

In the above-mentioned explanation, the first sensor 302 obtains the position information of the end portion ER in S1818. However, the present disclosure is not limited to this. The second sensor 304 in the differential mode may obtain the position information of the end portion ER.

### Operations and Effects

As explained above, the printing apparatus 10 according to the present embodiment executes the feeding process in which the print medium is fed such that the print medium can be conveyed with skewing suppressed. Specifically, skewing occurring in the conveyance of the print medium is suppressed to a certain amount or less, based on the position information of the end portion ER obtained by using the first sensor and the second sensor. Then, in the adjustment process executed after the feeding process, the output adjustment of the first sensor and the output adjustment in the single mode of the second sensor that are executed in the feeding process are omitted in the adjustment process executed after the feeding process. A time period required for the adjustment process is thereby reduced, and smooth transition to the printing process can be performed after the instruction to start the printing process.

### Third Embodiment

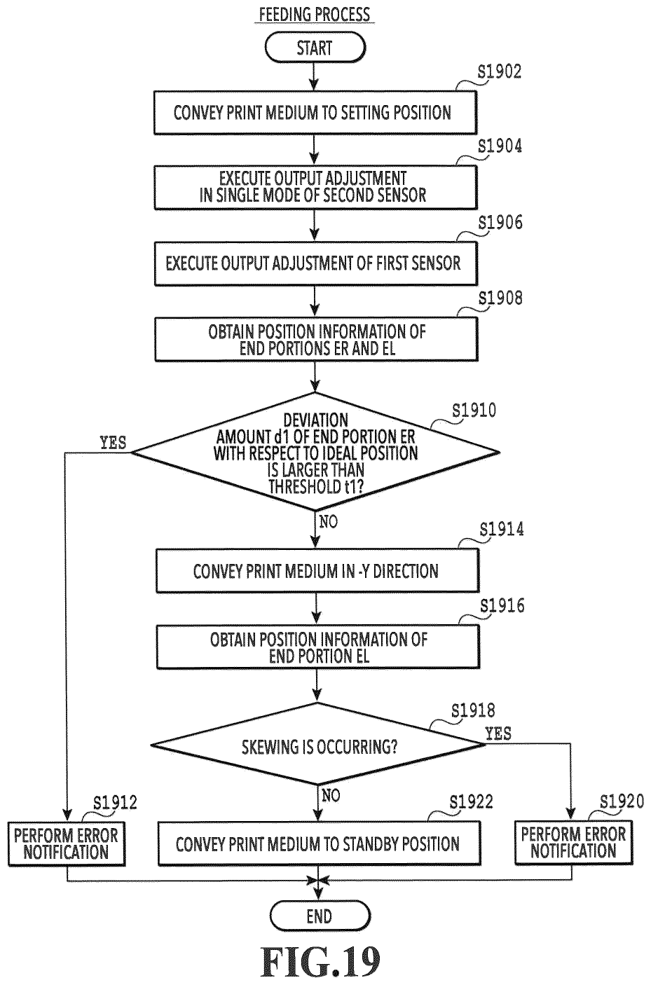

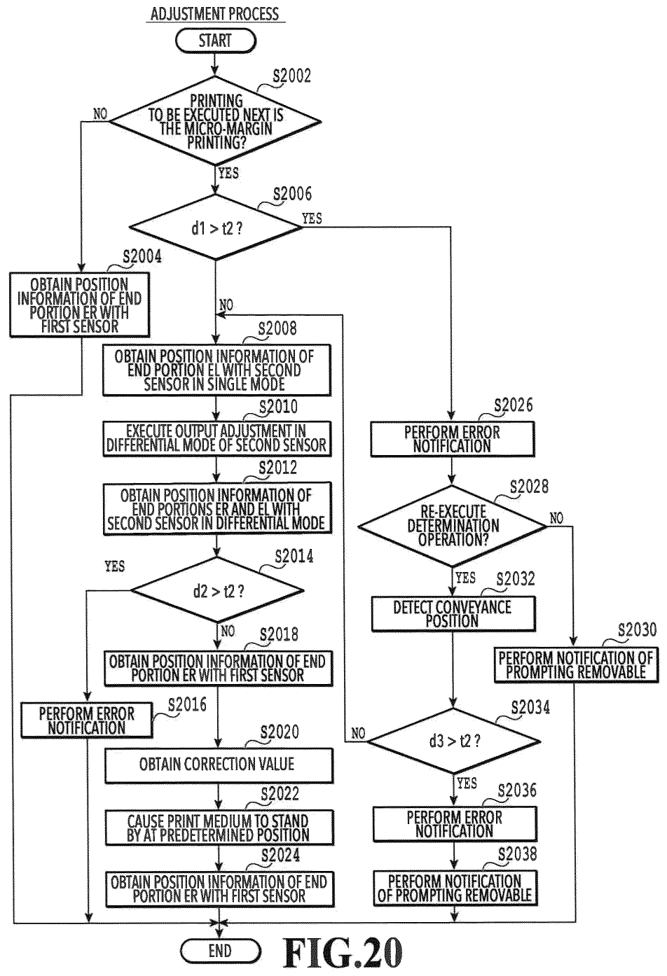

Next, a printing apparatus according to a third embodiment is explained with reference to FIGS. 19 and 20. In the following explanation, configurations identical or corresponding to the configurations of the printing apparatus according to the first embodiment described above are denoted by the same reference numerals as the reference numerals used in the first embodiment, and detailed explanation thereof is omitted.

The third embodiment is different from the second embodiment described above in that a deviation amount of the position of the conveyed print medium in the X direction from an ideal position is suppressed depending on the type of printing. In the following explanation of the feeding process and the adjustment process, a case where the sheet-shaped print medium MR unwound and conveyed from the roll R is conveyed is explained as an example.

### <Feeding Process>

FIG. 19 is a flowchart illustrating details of the feeding process executed in the printing apparatus 10 according to the present embodiment. The main controller 600 performs a series of processes illustrated in the flowchart of FIG. 19 by expanding program codes stored in the flash ROM 602 on the RAM 404 and executing the program codes. Alternatively, some or all of functions of steps in FIG. 19 may be executed by hardware such as an ASIC or an electric circuit.

In the case where the feeding process is started, first, in S1902, the main controller 600 conveys the print medium MR unwound from the roll R, to the setting position. Then, in S1904, the main controller 600 executes the output adjustment in the single mode of the second sensor 304. Next, in S1906, the main controller 600 executes the output adjustment of the first sensor 302. Thereafter, in S1908, the main controller 600 obtains the position information of the end portions ER and EL of the print medium MR. Since specific details of processes of S1902 to S1908 are the same as those of S1702 to S1708 described above, explanation thereof is omitted.

Next, in SI910, the main controller 600 determines whether a deviation amount d1 of the end portion ER with respect to the ideal position set in advance is larger than a threshold t1 or not, based on the position information of the end portion ER obtained in S1908. The ideal position is, for example, a position where the end portion of the print medium MR in the X direction should be located in terms of a design of the apparatus. Alternatively, the ideal position may be a position in the X direction where there is no extend off of the ink from the print medium MR in execution of the micro-margin printing, a position in the X direction where an extend-off amount is suppressed to a certain level or less, or the like. Moreover, the threshold t1 is set to, for example, an upper limit value of the deviation amount from the ideal position allowable in the margin printing. Specifically, in S1910, the main controller 600 obtains a difference between the position information of the end portion ER obtained in S1908 and the position information of the ideal position, as the deviation amount d1, and the determines whether this deviation amount d1 is larger than the threshold t1 or not. Note that the obtained deviation amount d1 is stored in, for example, a storage region such as the RAM 604.

If the main controller 600 determines that d1>t1 in S1910, the process proceeds to S1912, and the main controller 600 performs error notification indicating that the conveyance position of the print medium MR is not appropriate, and terminates this feeding process. In this case, the main controller 600 also performs notification prompting the user to retry the feeding process for the print medium MR unwound from the roll R held in the roll holding part 22. The user is notified of the error notification and the notification prompting the user to retry the feeding process, via the operation part 16, the notification part 18, and the like. As described above, in the present embodiment, the main controller 600 functions as a position detection part configured to detect that the print medium conveyed by the conveyance part 202 is at a printing position allowable in the printing to be executed.

If the main controller 600 determines that d1≤t1 in S1910, the process proceeds to S1914, and the main controller 600 moves the print medium MR at the setting position in the −Y direction by a predetermined amount. Then, in S1916, the main controller 600 obtains the position information of the end portion EL of the print medium MR. Thereafter, in S1918, the main controller 600 determines whether skewing is occurring in the conveyance of the print medium MR.

If the main controller 600 determines that skewing is occurring in the conveyance of the print medium MR in S1918, the process proceeds to S1920, and the main controller 600 performs error notification indicating that skewing is occurring in the conveyance of the print medium MR, and terminates this feeding process. Moreover, if the main controller 600 determines that no skewing is occurring in the conveyance of the print medium MR in S1918, the process proceeds to S1922, and the main controller 600 moves the print medium MR to the standby position where the print medium MR stands by after the feeding, and terminates this feeding process. Since specific details of processes of S1914 to S1922 are the same as those of S1710 to S1718 described above, explanation thereof is omitted.

### <Adjustment Process>

Next, the adjustment process executed after the feeding process in the printing apparatus 10 according to the present embodiment is explained. The adjustment process executed in the printing apparatus 10 of the present embodiment is explained below in detail with reference to FIG. 20.

FIG. 20 is a flowchart illustrating details of the adjustment process executed in the printing apparatus 10 according to the present embodiment. The main controller 600 performs a series of processes illustrated in the flowchart of FIG. 20 by expanding program codes stored in the flash ROM 602 on the RAM 404 and executing the program codes. Alternatively, some or all of functions of steps in FIG. 20 may be executed by hardware such as an ASIC or an electric circuit.

In the case where the adjustment process is started, first, in S2002, the main controller 600 determines whether the printing to be executed next is the micro-margin printing or not. If the main controller 600 determines that the printing to be executed next is not the micro-margin printing in S2002, in S2004, the main controller 600 obtains the position information of the end portion ER with the first sensor 302, and terminates this adjustment process. Specific details of processes of S2002 and S2004 are the same as those of S1802 and S1804 described above.

Moreover, if the main controller 600 determines that the printing to be executed next is the micro-margin printing in S2002, the process proceeds to S2006, and the main controller 600 determines whether the deviation amount d1 is larger than a threshold t2 or not. The threshold t2 is a value smaller than the threshold t1, and is set to, for example, an upper limit value of the deviation amount from the ideal position allowable in the micro-margin printing. Specifically, in S2006, the main controller 600 determines whether the deviation amount d1 obtained in S1910 and stored in the storage region such as the RAM 604 is larger than the threshold t2 set in advance or not.

In this case, since printing is performed very close to the end portion of the print medium in the micro-margin printing, the printing start position needs to be precisely managed in each operation of the scanning involving printing. Accordingly, in the case where the micro-margin printing is executed, the skewing and the position in the conveyance of the print medium also need to be managed more precisely than those in the case where no micro-margin printing is executed, that is the margin printing is executed. Accordingly, in the present embodiment, if the main controller 600 determines that the printing to be executed next is the micro-margin printing, first, in S2006, the main controller 600 determines whether the print medium is located at a position close to the ideal position more precisely. Then, after the output adjustment of the second sensor, in S2014 to be described later, the main controller 600 determines whether the conveyance position of the print medium is at a position close to the ideal position or not, based on the position of the end portion detected by the second sensor 304 in the differential mode with higher accuracy.

If the main controller 600 determines that d1St2 in S2006, the process proceeds to S2008, and the main controller 600 obtains the position information of the end portion EL of the print medium MR with the second sensor 304 in the single mode. Next, in S2010, the main controller 600 executes the output adjustment in the differential mode of the second sensor 304. Then, in S2012, the main controller 600 obtains the position information of the end portions ER and EL of the print medium MR with the second sensor 304 in the differential mode. Specific details processes of S2008 to S2012 are the same as those of S1806 to S1810 described above.

Next, in S2014, the main controller 600 determines whether a deviation amount d2 of the end portion ER with respect to the ideal position is larger than the threshold t2 or not, based on the position information of the end portion ER obtained in S2012. Specifically, in S2014, the main controller 600 obtains a difference between the position information of the end portion ER obtained in S2012 and the position information of the ideal position, as the deviation amount d2, and determines whether the deviation amount d2 is larger than the threshold t2 or not. If the main controller 600 determines that d2>t2 in S2014, the process proceeds to S2016, and the main controller 600 performs error notification indicating that the conveyance position of the print medium MR is not appropriate for the micro-margin printing, and terminates this adjustment process. In this case, notification prompting removable of the print medium MR or notification prompting retry of the feeding process may be performed.

Moreover, if the main controller 600 determines that d2:St2 in S2014, the process proceeds to S2018, and the main controller 600 obtains the position information of the end portion ER of the print medium MR with the first sensor 302. Next, in S2020, the main controller 600 obtains the correction value for correcting the position information obtained based on the detection result of the first sensor 302, based on the position information of the end portion ER obtained in S2012 and the position information of the end portion ER obtained in S2018. Then, in S2022, the main controller 600 causes the print medium MR to stand by at a predetermined position. Thereafter, in S2024, the main controller 600 obtains the position information of the end portion ER of the print medium MR with the first sensor 302, and terminates the adjustment process. Specific details of processes of S2018 to S2024 are the same as those of S1812 to S1818 described above.

Moreover, if the main controller 600 determines that d1>t2 in S2006, the process proceeds to S2026, and the main controller 600 performs error notification indicating that the conveyance position of the print medium MR does not suit the micro-margin printing. Moreover, in S2026, the main controller 600 displays a selection screen prompting user to select whether to re-execute the determination operation of the conveyance position or cancel the printing based on the print job, on the operation part 16.

Thereafter, in S2028, the main controller 600 determines whether the re-execution of the determination operation is selected or not. If the main controller 600 determines that the re-execution of the determination operation is not selected, that is the printing is canceled in S2028, in S2030, the main controller 600 performs notification of prompting removable of the print medium MR (roll R), and terminates this adjustment process. The notification of prompting removable of the print medium MR is executed via the operation part 16 and the notification part 18.

Moreover, if the main controller 600 determines that the re-execution of the determination operation is selected in S2028, in S2032, the conveyance position of the print medium MR is re-detected. Specifically, in S2032, first, the first sensor 302 or the second sensor 304 in the single mode re-obtains the position information of the end portion ER of the print medium MR. Thereafter, a difference between the obtained position information of the end portion ER and the position information of the ideal position is obtained as a deviation amount d3. Then, in S2034, the main controller 600 determines whether the deviation amount d3 obtained in S2032 is larger than the threshold t2 or not.

If the main controller 600 determines that d3St2 in S2034, the process proceeds to S2008. If the main controller 600 determines that d3>t2 in S2034, the process proceeds to S2036, and the main controller 600 performs error notification indicating that a conveyance state of the print medium MR does not suit the micro-margin printing. Then, in S2038, the main controller 600 displays the screen prompting removal of the print medium MR (roll R), and terminates this adjustment process.

### Modification

Although the deviation amount d2 is obtained based on the position information of the end portion ER in the above-mentioned explanation, the present disclosure is not limited to this, and the deviation amount d2 may be obtained based on the position information of the end portion EL. Moreover, although the error notification of S1912, S2016, and S2026 is executed based on the deviation amount of the end portion of the print medium from the ideal position, the present disclosure is not limited to this. For example, the error notification may be executed based on a level of skewing of the print medium MR or a result of comparison with anything similar to the level of skewing.

### Operations and Effects

As explained above, in the printing apparatus 10 of the present embodiment, in the feeding process, the conveyance position of the print medium in the X direction is set to a position allowable in the margin printing. Moreover, in the adjustment process, in the case where the micro-margin printing is to be executed, the printing is executed only if the conveyance position of the print medium in the X direction is at the position allowable in the micro margin printing. This enables the feeding process and the adjustment process to be executed in the conveyance state suitable for the printing to be executed next while suppressing an increase in a time period required for the processes, and usability is improved for the user.

### Fourth Embodiment

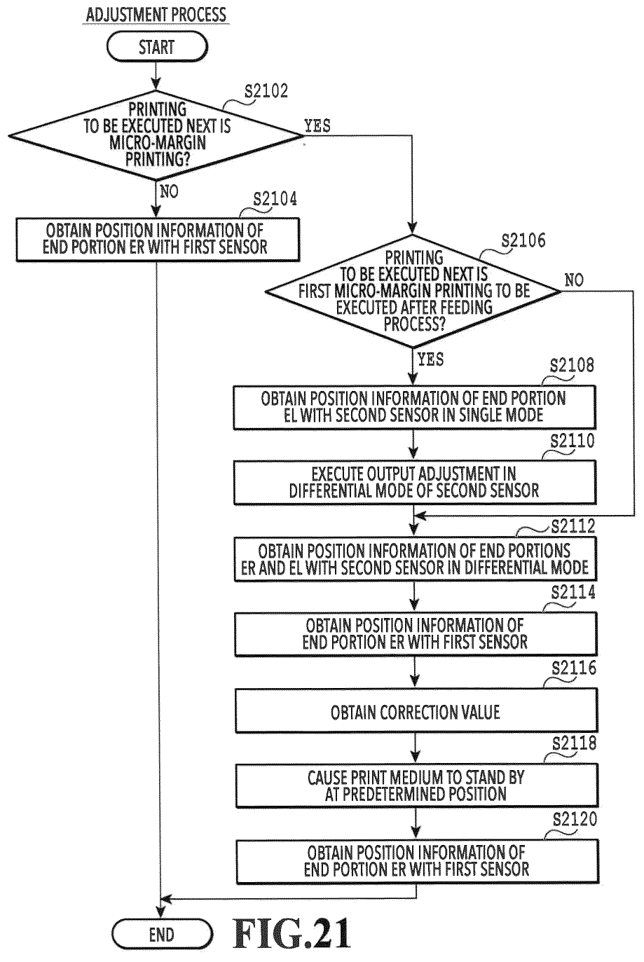

Next, a printing apparatus according to a fourth embodiment is explained with reference to FIG. 21. In the following explanation, configurations identical or corresponding to the configurations of the printing apparatus according to the first embodiment described above are denoted by the same reference numerals as the reference numerals used in the first embodiment, and detailed explanation thereof is omitted.

In the case where the micro-margin printing is executed at least once after the replacement of the roll R and the feeding process, in the printing apparatus 10, the output adjustment in the differential mode of the second sensor 304 using the conveyed print medium M has been executed in the previous micro-margin printing. Accordingly, in the fourth embodiment, the output adjustment in the differential mode of the second sensor 304 is executed depending on whether the printing to be executed next is the micro-margin printing to be executed for the first time after the feeding process or not. The fourth embodiment is different from the second embodiment described above in this point. In the following explanation of the adjustment process, a case where the sheet-shaped print medium MR unwound and conveyed from the roll R is conveyed is explained as an example.

### <Adjustment Process>

The adjustment process executed in the printing apparatus 10 according to the present embodiment is explained. FIG. 21 is a flowchart illustrating details of the adjustment process executed in the printing apparatus according to the present embodiment. The main controller 600 performs a series of processes illustrated in the flowchart of FIG. 21 by expanding program codes stored in the flash ROM 602 on the RAM 604 and executing the program codes. Alternatively, some or all of functions of steps in FIG. 21 may be executed by hardware such as an ASIC or an electric circuit.

In the case where the adjustment process is started, first, in S2102, the main controller 600 determines whether the printing to be executed next is the micro-margin printing or not. If the main controller 600 determines that the printing to be executed next in not the micro-margin printing in S2102, in S2104, the main controller 600 obtains the position information of the end portion ER of the print medium MR with the first sensor 302, and terminates this adjustment process. Specific details of processes of S2102 and S2104 are the same as those of S1802 and S1804 described above.

If the main controller 600 determines that the printing to be executed next is the micro-margin printing in S2102, the process proceeds to S2106, and the main controller 600 determines whether the printing to be executed next is the first micro-margin printing to be executed after the feeding process or not. In the printing apparatus 10, for example, in the case where the feeding process is completed after the replacement of the roll R, a flag representing non-execution of the micro-margin printing is set to ON. Then, in the case where the micro-margin printing is executed, the flag is set to OFF. Accordingly, in S2102, the main controller 600 determines whether the flag is ON or not. If the flag is ON, in S2106, the main controller 600 determines that the printing to be executed next is the first micro-margin printing to be executed after the feeding process. If the flag is OFF, in S2106, the main controller 600 determines that the printing to be executed next is not the first micro-margin printing to be executed after the feeding process. The determination method of determining whether the printing to be executed next is the first printing to be executed or not is not limited to the above-mentioned method, and any of various publicly-known determination methods can be used.

If the main controller 600 determines that the printing to be executed next is not the first micro-margin printing to be executed after the feeding process in S2106, that is the second or subsequent micro-margin printing to be executed after the feeding process, the process proceeds to S2112 to be described later. Moreover, if the main controller 600 determines that the printing to be executed next is the first micro-margin printing to be executed after the feeding process in S2106, the process proceeds to S2108, and the main controller 600 obtains the position information of the end portion EL of the print medium MR with the second sensor 304 in the single mode. Then, in S2110, the main controller 600 executes the output adjustment in the differential mode of the second sensor 304.

Next, in S2112, the main controller 600 obtains the position information of the end portions ER and EL of the print medium MR with the second sensor 304 in the differential mode. Then, in S2114, the main controller 600 obtains the position information of the end portion ER of the print medium MR with the first sensor 302. Thereafter, in S2116, the main controller 600 obtains the correction value for correcting the position information obtained based on the detection result of the first sensor, based on the position information of the end portion ER obtained in S2114 and the position information of the end portion ER obtained in S2112.

Then, in S2118, the main controller 600 causes the print medium MR to stand by at the predetermined position. Moreover, in S2120, the main controller 600 obtains the position information of the end portion ER of the print medium MR with the first sensor 302, and terminates this adjustment process. Since specific details of processes of S2108 to S2120 are the same as those of S1806 to S1818 described above, detailed explanation thereof is omitted.

### Operations and Effects

As explained above, in the case where the printing to be executed next is the second or subsequent micro-margin printing to be executed after the feeding process, the printing apparatus 10 according to the present embodiment omits execution of the output adjustment in the differential mode of the second sensor and the process relating to the output adjustment. Specifically, the process (S2108) of obtaining the position information of the end portion EL with the second sensor in the single mode and the output adjustment (S2110) in the differential mode of the second sensor are omitted. This reduces the time period required for the adjustment process in the case where the printing apparatus 10 executes the second or subsequent micro-margin printing after the feeding process, and smooth transition to the printing process can be performed.

### OTHER EMBODIMENTS

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

Although the first sensor 302 and the second sensor 304 are provided in the carriage 216 in the above-mentioned embodiments, the present disclosure is not limited to this. The first sensor 302 and the second sensor 304 may be provided separately from the carriage 216 as long as the configuration is such that the first sensor 302 and the second sensor 304 can move synchronously with the carriage 216. Accordingly, in this case, the first sensor 302 and the second sensor 304 are configured to be movable in synchronization with each other.

The various forms illustrated in the embodiments and the modifications of the embodiments described above may be combined as appropriate.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

According to the present disclosure, it is possible to suppress an increase in a waiting time period for execution of printing.

This application claims the benefit of Japanese Patent Application No. 2024-163989, filed Sep. 20, 2024, which is hereby incorporated by reference herein in its entirety.

What is claimed is:

1. A printing apparatus comprising:
a carriage in which a print head configured to perform printing by ejecting ink to a conveyed print medium is mounted, the carriage movable in a width direction of the print medium intersecting a conveyance direction of the print medium;
a first detection unit provided in the carriage and including a light emitting part configured to emit light to the print medium and three light receiving parts configured to receive reflected light from the print medium and provided at positions varying from one another in the width direction, the first detection unit capable of being switched between a first mode in which the first detection unit detects an end portion of the print medium based on an output corresponding to an amount of received light in one of the light receiving parts and a second mode in which the first detection unit detects the end portion based on a difference between outputs corresponding to amounts of received light in two of the light receiving parts not used in the first mode;
an obtaining unit configured to obtain position information of the end portion based on an output from the first detection unit in the first mode and obtain the position information of the end portion based on an output from the first detection unit in the second mode; an adjusting unit configured to execute first output adjustment in which the adjusting unit adjusts the output from the first detection unit in the first mode and second output adjustment in which the adjusting unit adjusts the output from the first detection unit in the second mode; and
a print control unit capable of selectively executing first printing in which the position information of the end portion is not obtained during printing and second printing in which the position information of the end portion is obtained during printing, wherein the adjusting unit
executes the first output adjustment before execution of the first printing, and
executes the first output adjustment and the second output adjustment before execution of the second printing.

2. The printing apparatus according to claim 1, further comprising a second detection unit provided in the carriage and including a light emitting part configured to emit light to the print medium and a light receiving unit configured to receive reflected light from the print medium, wherein
the first detection unit is provided on one side of the carriage in the width direction,
the second detection unit is provided on the other side of the carriage in the width direction,
the obtaining unit further obtains the position information of the end portion based on an output from the second detection unit, and
the adjusting unit further
executes third output adjustment in which the adjusting unit adjusts the output from the second detection unit, and
executes the third output adjustment before the execution of the first printing and the second printing.

3. The printing apparatus according to claim 2, further comprising a correction value obtaining unit configured to obtain a difference between the position information of the end portion obtained in the obtaining unit based on the output from the first detection unit in the second mode and the position information of the end portion obtained in the obtaining unit based on the output from the second detection unit, as a correction value for correcting the position information of the end portion obtained in the obtaining unit based on the output from the second detection unit.

4. The printing apparatus according to claim 3, further comprising a setting unit configured to correct the position information of the end portion obtained in the obtaining unit based on the output from the second detection unit, with the correction value, and set the corrected position information as a reference value that is a printing start position in the width direction in the execution of the second printing.

5. The printing apparatus according to claim 1, further comprising:
a holding unit configured to hold the print medium;
a conveyance unit configured to convey the print medium held by the holding unit; and a skewing detection unit configured to detect skewing occurring in conveyance of the print medium by the conveyance unit, based on the position information of the end portion at a first position and the position information of the end portion at a second position, the first position being a position of the replaced print medium held by the holding unit after the conveyance by the conveyance unit, the second position being a position of the print medium conveyed by the conveyance unit from the first position by a predetermined amount, wherein
the adjusting unit executes the first output adjustment before the detection of skewing by the skewing detection unit.

6. The printing apparatus according to claim 1, further comprising:
a holding unit configured to hold the print medium; and
a conveyance unit configured to convey the print medium held in the holding unit; and
a position detection unit configured to detect that a first deviation amount is equal to or less than a first threshold, the first deviation amount being a deviation amount of the position information of the end portion at a first position from a predetermined position, the first position being a position of the replaced print medium held by the holding unit after the conveyance by the conveyance unit, the first threshold indicating that the print medium conveyed by the conveyance unit is at a first conveyance position allowable in the first printing, wherein
the adjusting unit executes the first output adjustment before the execution of the detection by the position detection unit.

7. The printing apparatus according to claim 6, wherein, in a case where the execution of the second printing is instructed in a state where the replaced print medium is located at a standby position at which the print medium is conveyable by the conveyance unit, the position detection unit detects that the first deviation amount is equal to or less than a second threshold, before the execution of the second output adjustment, the second threshold indicating that the print medium conveyed by the conveyance unit is at a second conveyance position allowable in the second printing.

8. The printing apparatus according to claim 7, further comprising a notification unit configured to, in a case where the position detection unit does not detect that the print medium is at the second conveyance position, give notification prompting selection of whether to cancel the second printing or execute re-obtaining of the position information of the end portion of the print medium conveyed by the conveyance unit and re-detection of the second conveyance position.

9. The printing apparatus according to claim 7, wherein, after the execution of the second output adjustment, the position detection unit detects that a second deviation amount is equal to or less the second threshold, the second deviation amount being a deviation amount, from the predetermined position, of the position information of the end portion obtained in the obtaining unit based on the output from the first detection unit in the second mode.

10. The printing apparatus according to claim 1, further comprising a holding unit configured to hold the print medium, wherein
in a case where the second printing to be executed is the second or subsequent second printing after replacement of the print medium in the holding unit, the first output adjustment and the second output adjustment are not executed.

11. The printing apparatus according to claim 1, wherein
the first printing is printing in which a printing region is fixed based on the position information of the end portion before the printing, and
the second printing is printing in which the printing region is changeable based on the position information of the end portion during the printing.

12. The printing apparatus according to claim 11, wherein
the first printing is printing in which a visible margin is provided in the end portion of the print medium, and
the second printing is printing in which a margin is not provided or a margin less likely to be visually recognized is provided in the end portion of the print medium.

13. A control method of a printing apparatus including:
a carriage in which a print head configured to perform printing by ejecting ink to a conveyed print medium is mounted, the carriage movable in a width direction of the print medium intersecting a conveyance direction of the print medium;
a first detection unit provided in the carriage and including a light emitting part configured to emit light to the print medium and three light receiving parts configured to receive reflected light from the print medium and provided at positions varying from one another in the width direction, the first detection unit capable of being switched between a first mode in which the first detection unit detects an end portion of the print medium based on an output corresponding to an amount of received light in one of the light receiving parts and a second mode in which the first detection unit detects the end portion based on a difference between outputs corresponding to amounts of received light in two of the light receiving parts not used in the first mode;
an obtaining unit configured to obtain position information of the end portion based on an output from the first detection unit in the first mode and obtain the position information of the end portion based on an output from the first detection unit in the second mode; and
an adjusting unit configured to execute first output adjustment in which the adjusting unit adjusts the output from the first detection unit in the first mode and second output adjustment in which the adjusting unit adjusts the output from the first detection unit in the second mode, the control method comprising:
a first adjustment step of executing the first output adjustment; and
a second adjustment step of executing the first output adjustment and the second output adjustment, wherein
the first adjustment step is executed before execution of first printing in which the position information of the end portion is not obtained during printing, and
the second adjustment step is executed before execution of second printing in which the position information of the end portion is obtained during printing.

14. The control method according to claim 13, wherein
the printing apparatus further includes a second detection unit provided in the carriage and including a light emitting part configured to emit light to the print medium and a light receiving unit configured to receive reflected light from the print medium, wherein
the obtaining unit further obtains the position information of the end portion based on an output from the second detection unit, and
the adjusting unit further
executes third output adjustment in which the adjusting unit adjusts the output from the second detection unit, and
executes the third output adjustment in the first adjustment step and the second adjustment step.

15. The control method according to claim 14, further comprising a correction value obtaining step of obtaining a difference between the position information of the end portion obtained in the obtaining unit based on the output from the first detection unit in the second mode and the position information of the end portion obtained in the obtaining unit based on the output from the second detection unit, as a correction value for correcting the position information of the end portion obtained in the obtaining unit based on the output from the second detection unit.

16. The control method according to claim 13, wherein the printing apparatus further includes:
a holding unit configured to hold the print medium; and
a conveyance unit configured to convey the print medium held in the holding unit, and
the control method comprises a skew detection step of detecting skewing occurring in conveyance of the print medium by the conveyance unit, based on the position information of the end portion at a first position and the position information of the end portion at a second position, the first position being a position of the print medium conveyed by the conveyance unit in a case where replacement of the print medium is performed in the holding unit, the second position being a position of the print medium conveyed by the conveyance unit from the first position by a predetermined amount, and the first adjustment step is executed before the skew detection step.

17. The control method according to claim 13, wherein
the printing apparatus further includes:
a holding unit configured to hold the print medium; and
a conveyance unit configured to convey the print medium held in the holding unit; and the control method further comprises a first position detection step of detecting that a first deviation amount is equal to or less than a first threshold, the first deviation amount being a deviation amount of the position information of the end portion at a first position from a predetermined position, the first position being a position of the print medium conveyed by the conveyance unit in a case where replacement of the print medium is performed in the holding unit, the first threshold indicating that the print medium is at a first conveyance position allowable in the first printing, and
the first adjustment step is executed before the first position detection step.

18. The control method according to claim 16, wherein, in a case where the execution of the second printing is instructed in a state where the replaced print medium is located at a standby position at which the print medium is conveyable by the conveyance unit, the first output adjustment is not executed in the second adjustment step.

19. The control method according to claim 17, further comprising a second position detection step of, in a case where the execution of the second printing is instructed in a state where the replaced print medium is located at a standby position at which the print medium is conveyable by the conveyance unit, detecting that the first deviation amount is equal to or less than a second threshold before the execution of the second output adjustment, the second threshold indicating that the print medium is at a second conveyance position allowable in the second printing.

20. The control method according to claim 19, further comprising a notification step of, in a case where the print medium is not detected at the second conveyance position in the second position detection step, giving notification prompting selection of whether to cancel the second printing or execute re-obtaining of the position information of the end portion of the print medium conveyed by the conveyance unit and re-detection of the second conveyance position.
